(19) United States
(12) Patent Application Publication
(10) Pub. No.: US 2017/0373928 A1
(43) Pub. Date: Dec. 28, 2017

(54) COMPUTER-READABLE RECORDING MEDIUM, INFORMATION PROCESSING APPARATUS, AND VM SWITCHING METHOD

(71) Applicant: FUJITSU LIMITED, Kawasaki-shi (JP)

(72) Inventors: Yusuke UJIIE, Kawasaki (JP); Motoyuki Tanisho, Yokohama (JP); Tetsuo EHARA, Yokohama (JP)

(73) Assignee: FUJITSU LIMITED, Kawasaki-shi (JP)

(21) Appl. No.: 15/604,710

(22) Filed: May 25, 2017

(30) Foreign Application Priority Data
Jun. 24, 2016 (JP) 2016-125899

(51) Int. Cl. H04L 12/24; H04L 12/26; H04L 12/931

(52) U.S. Cl. CPC H04L 41/0668; H04L 43/04; H04L 49/70

(57) ABSTRACT

A server detects an abnormality of a VM being a transfer destination of a packet; rewrites, when the VM is switched, a first relationship between a transfer destination MAC address and a port number of the VM before switching to a first relationship between the MAC address and a port number of the switched VM; decides, from the port number being matched based on the rewritten first relationship and a second relationship among a port number of the switched VM, a transfer destination MAC address, and a transfer destination IP address, the transfer destination MAC address and the transfer destination IP address of the switched VM; rewrites the transfer destination MAC address and the transfer destination IP address included in the header of the packet received from a network to the decided MAC address and the IP address; and transfers the rewritten packet to the switched VM.

### CROSS-REFERENCE TO RELATED APPLICATION

This application is based upon and claims the benefit of priority of the prior Japanese Patent Application No. 2016-125899, filed on Jun. 24, 2016, the entire contents of which are incorporated herein by reference.

### FIELD

The embodiments discussed herein are related to a computer-readable recording medium or the like.

### BACKGROUND

In recent years, in order to speed up a process on increasing communication traffic, there is a Network Functions Virtualization (NFV) technology in which a server creates a plurality of VMs in the server and a packet process is performed by using a virtual network function (VNF) that is connected to each of the VMs. With this NFV technology, the packet process is not performed in a normal state due to congestion or a failure of a packet in a VM or a VNF. Thus, the server performs a process of switching the VM to another VM when the packet process becomes abnormal.

For example, there is a known technology that a network controller provided outside the server instructs a virtual switch to switch NVs (for example, see Patent Document 1). In this technology, an application fault detection module included in a server detects a fault of a virtual appliance and sends, in accordance with the detection of the fault, a fault notification to an appliance fault control notification module. The appliance fault control notification module sends an appliance fault controller notification message to a network controller. Then, the network controller decides, in accordance with the reception of the appliance fault controller notification message, a change in components to be executed and instructs the virtual switch to switch NVs. Here, the appliance corresponds to the VNF.

Patent Document 1: Japanese Laid-open Patent Publication No. 2015-62282

However, in the conventional technology, there is a problem in that it takes time to switch the VMs. For example, in the technology in which the network controller instructs the virtual switch to switch NVs, because the network controller is provided outside the server, it takes time to switch the VMs.

### SUMMARY

According to an aspect of an embodiment, a non-transitory computer-readable recording medium has stored therein a VM switching program. The VM switching program causes a computer to execute a process. The process includes detecting an abnormality of a VM that is a transfer destination of a packet and rewriting, when switching of the VM has been performed, a first association relationship between a transfer destination MAC address and a port number of the VM that is before the switching to a first association relationship between the MAC address and a port number of the switched VM. The process includes deciding, from the port number that is matched based on the rewritten first association relationship and a second association relationship among a port number of the switched VM that is the transfer destination, a transfer destination MAC address, and a transfer destination IP address, the transfer destination MAC address and the transfer destination IP address of the switched VM. The process includes rewriting both the transfer destination MAC address and the transfer destination IP address that are included in the header of the packet received from an external network to both the decided MAC address and the decided IP address. The process includes transferring the rewritten packet to the switched VM.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating the functional configuration of a server according to a first embodiment;

FIG. 2 is a schematic diagram illustrating an example of the data structure of a transfer table according to the first embodiment;

FIG. 3 is a schematic diagram illustrating an example of the data structure of a MAC/IP edit table according to the first embodiment;

FIG. 4 is a schematic diagram illustrating an example of a process before the switching of VMs according to the first embodiment;

FIG. 5A is a schematic diagram illustrating an example of a VM switching process according to the first embodiment;

FIG. 5B is a schematic diagram illustrating another example of the VM switching process according to the first embodiment;

FIG. 5C is a schematic diagram illustrating another example of the VM switching process according to the first embodiment;

FIG. 6 is a flowchart illustrating an example of the flow of the VM switching process according to the first embodiment;

FIG. 7 is a flowchart illustrating an example of the flow of the VM switching process when transferring from a WAN to a VM;

FIG. 8 is a flowchart illustrating an example of the flow of an update process of the transfer table;

FIG. 9 is a flowchart illustrating an example of the flow of the VM switching process when transferring from a WAN to a VM;

FIG. 10 is a block diagram illustrating the functional configuration of a server according to a second embodiment;

FIG. 11A is a schematic diagram (1) illustrating an example of an abnormality detecting process according to the second embodiment;

FIG. 11B is a schematic diagram (2) illustrating an example of the abnormality detecting process according to the second embodiment;

FIG. 12 is a flowchart illustrating an example of the flow of the abnormality detecting process according to the second embodiment;

FIG. 13 is a flowchart illustrating an example of the flow of a process performed on the VM side according to the second embodiment;

FIG. 14 is a block diagram illustrating the functional configuration of a server according to a third embodiment;

FIG. 15 is a schematic diagram illustrating an example of an abnormality detecting process according to the third embodiment;

FIG. 16 is a flowchart illustrating an example of the flow of the abnormality detecting process according to the third embodiment;

FIG. 17 is a block diagram illustrating the functional configuration of a server according to a fourth embodiment;

FIG. 18 is a schematic diagram illustrating an example of an abnormality detecting process according to the fourth embodiment;

FIG. 19 is a flowchart illustrating an example of the flow of an abnormality detecting process according to the fourth embodiment;

FIG. 20 is a flowchart illustrating an example of the flow of a process performed on the VM side according to the fourth embodiment;

FIG. 21 is a block diagram illustrating the functional configuration of a server according to a fifth embodiment;

FIG. 22 is a schematic diagram illustrating an example of an abnormality detecting process according to the fifth embodiment;

FIG. 23 is a flowchart illustrating an example of the flow of the abnormality detecting process according to the fifth embodiment;

FIG. 24 is a flowchart illustrating an example of the flow of a process performed on the VM side according to the fifth embodiment;

FIG. 25 is a block diagram illustrating the functional configuration of a server according to a sixth embodiment;

FIG. 26 is a schematic diagram illustrating an example of an abnormality detecting process according to the sixth embodiment;

FIG. 27 is a flowchart illustrating an example of the flow of the abnormality detecting process according to the sixth embodiment;

FIG. 28 is a flowchart illustrating an example of a process performed on the VM side according to the sixth embodiment;

FIG. 29 is a block diagram illustrating the functional configuration of a server according to a seventh embodiment;

FIG. 30 is a schematic diagram illustrating an example of an abnormality detecting process according to the seventh embodiment;

FIG. 31 is a flowchart illustrating an example of an abnormality detecting process according to the seventh embodiment;

FIG. 32 is a flowchart illustrating the flow of a process performed on the VM side according to the seventh embodiment; and

FIG. 33 is a block diagram illustrating an example of a computer that executes a VM switching program.

### DESCRIPTION OF EMBODIMENTS

Preferred embodiments of the present invention will be explained with reference to accompanying drawings. Furthermore, the present invention is not limited to the embodiments.

### [a] First Embodiment

### Configuration of a Server according to a First Embodiment

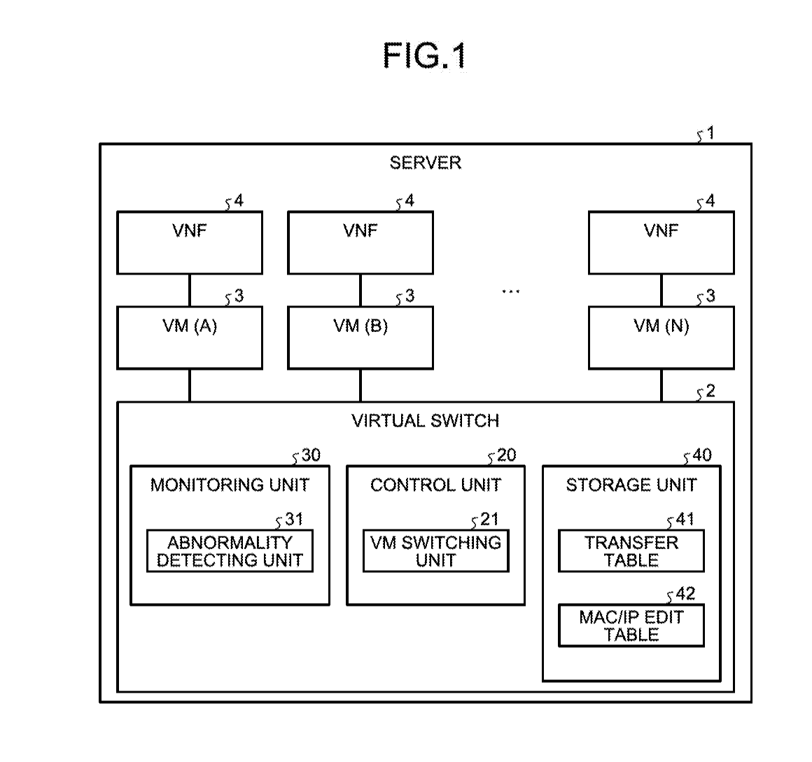

FIG. 1 is a block diagram illustrating the functional configuration of a server according to a first embodiment. As illustrated in FIG. 1, a server 1 uses the technology of Network Functions Virtualization (NFV) that virtualizes network functions and includes a virtual switch 2 and a plurality of VMs 3. The VMs 3 are connected to respective virtual network functions (VNFs) 4 via a network. The VNFs 4 are software running on the VMs 3 and are, as an example, voice packet communication functions. When a VM is switched, taking over of the voice packet communication function itself (as application software) is not needed. Furthermore, in FIG. 1, the number of VMs 3 is assumed to be N (N>2); however, the number of VMs 3 is not limited to this and two VMs 3 may also be used or 10 VMs 3 may also be used. Namely, the number of VMs 3 is not limited to this as long as a spare VM 3 that is different from the operated VMs 3 is present. In the embodiment, in order to distinguish the plurality of the VMs 3, the symbols of A, B, . . . , and N or 1, 2, . . . may sometimes be represented in the brackets on the right side of the VM.

The server 1 creates the plurality of the VMs 3 in the server 1 in order to speed up the process on communication traffic and then performs a packet process in the VNFs 4 connected to the respective VMs 3 via the network. Furthermore, the server 1 is an example of an information processing apparatus.

The virtual switch 2 detects an abnormality of the VM 3 that is the transfer destination of a packet and switches the VM 3 in which the abnormality has been detected to the new VM 3. Furthermore, the virtual switch 2 includes a control unit 20, a monitoring unit 30, and a storage unit 40.

The control unit 20 and the monitoring unit 30 include an internal memory that stores therein control data and programs in which various kinds of procedures are prescribed, whereby the control unit 20 and the monitoring unit 30 execute various kinds of processes. Furthermore, the control unit 20 and the monitoring unit 30 correspond to, for example, an electronic circuit in an integrated circuit, such as an application specific integrated circuit (ASIC), a field programmable gate array (FPGA), or the like. Alternatively, the control unit 20 and the monitoring unit 30 correspond to an electronic circuit, such as a central processing unit (CPU), a micro processing unit (MPU), or the like.

The storage unit 40 corresponds to a storage device, such as a nonvolatile semiconductor memory device including, for example, a flash memory, a Ferroelectric Random Access Memory (FRAM) (registered trademark), or the like. The storage unit 40 includes a transfer table 41 and a MAC/IP edit table 42. The transfer table 41 stores therein MAC addresses and the port numbers of the destination that are used when packets are transferred. The MAC/IP edit table 42 is a table that is used to edit the MAC addresses and the IP addresses of the destination and the transmission source of the packets. The transfer table 41 and the MAC/IP edit table 42 will be described in detail later.

The control unit 20 includes a VM switching unit 21.

If an abnormality of the VM 3 is detected, the VM switching unit 21 switches the VM 3 in which the abnormality has been detected to the new VM 3. Namely, if an abnormality is detected in one of the VMs 3, the VM switching unit 21 switches the VM (A) in which the abnormality has been detected to the new VM (B). For example, if the abnormality of the VM 3 is detected by an abnormality detecting unit 31, which will be described later, the switching of the VMs 3 is performed and the VM switching unit 21 decides, based on the transfer table 41 and the MAC/IP edit table 42, both the MAC address and the IP address of the new VM 3 that has been switched. The VM switching unit 21 rewrites both the MAC address and the IP address that are included in the header of the packet received from external network to the decided MAC address and the decided IP address. The VM switching unit 21 transfers the packet in which both the addresses have been rewritten to the new VM 3 that has been switched.

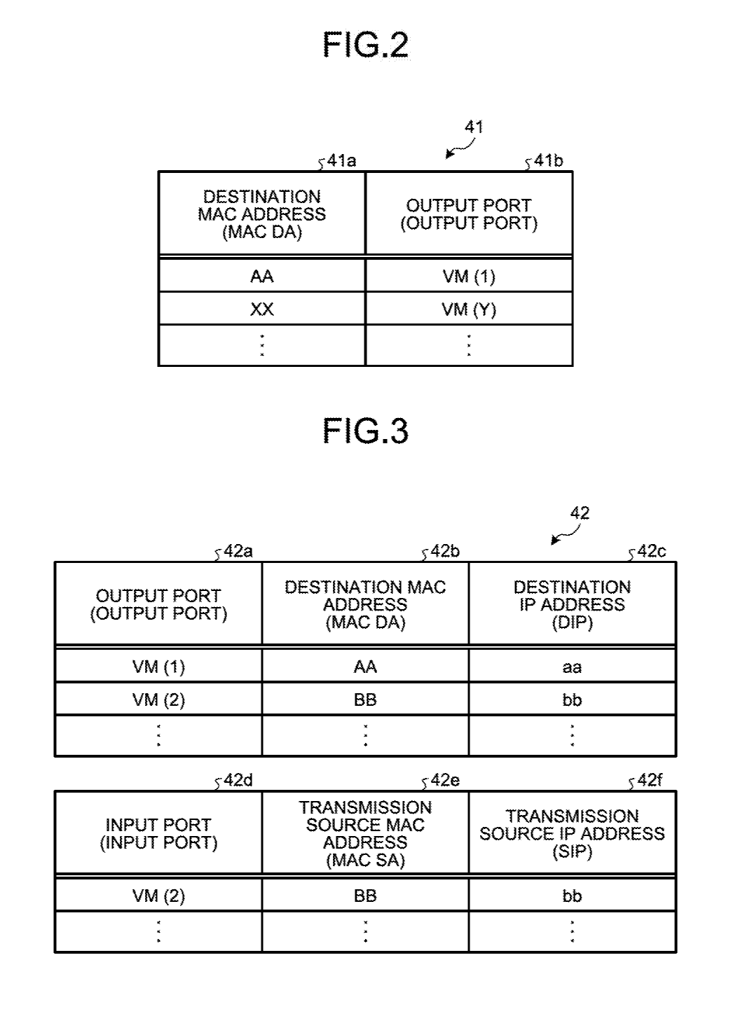

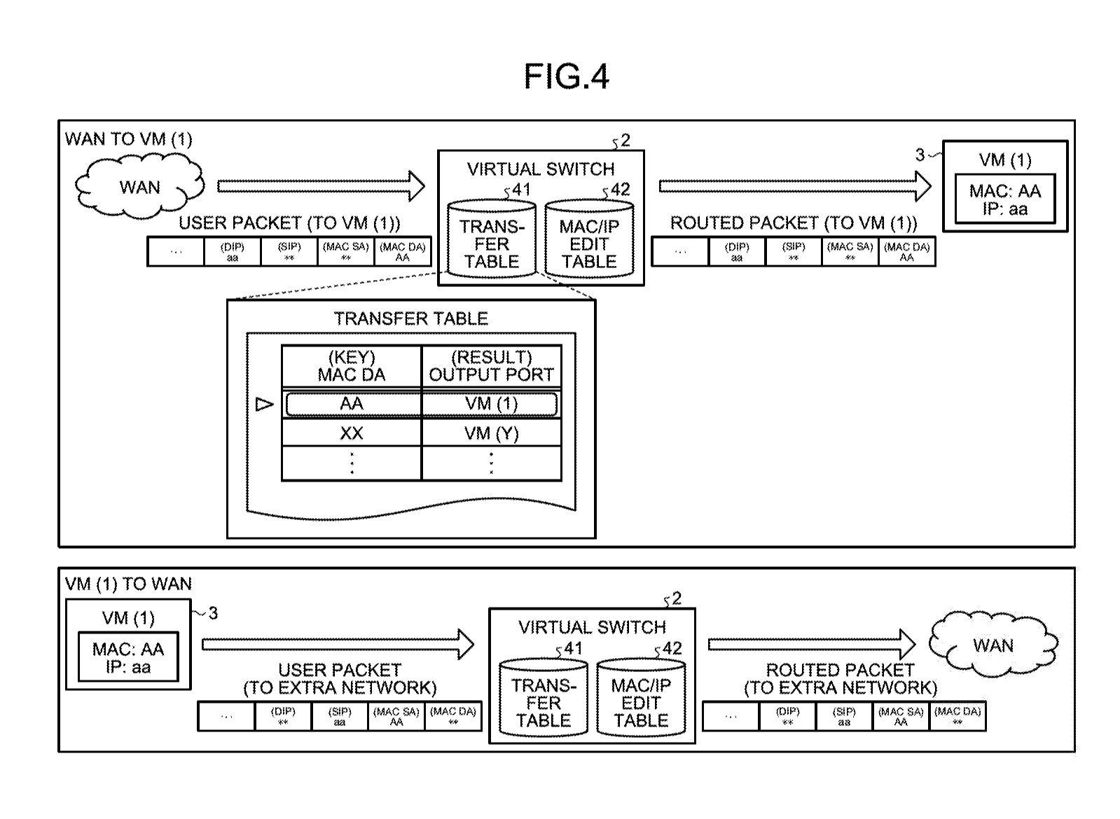

In the following, an example of the data structure of the transfer table 41 and the MAC/IP edit table 42 will be described with reference to FIGS. 2 and 3.

### Example of the Data Structure of the Transfer Table

FIG. 2 is a schematic diagram illustrating an example of the data structure of the transfer table according to the first embodiment. As illustrated in FIG. 2, the transfer table 41 stores therein, in associated manner, a destination MAC address 41a and an output port 41b. The destination MAC address 41a is the MAC address of the VM 3 that is the transfer destination of the packet and corresponds to the MAC DA. The output port 41b corresponds to the output port of the VM 3 that is the transfer destination of the packet. When the VMs 3 are switched, the output port 41b is rewritten to the output port addressed to the switched VM 3. For example, if an abnormality of the VM 3 is detected, the VM switching unit 21 rewrites the output port that is stored in the transfer table 41 and that is associated with the destination MAC address included in the header of the packet to be received to the output port addressed to the new VM 3 that has been switched. Furthermore, the transfer table 41 is an example of a first association relationship.

### Example of the Data Structure of the MAC/IP Edit Table

FIG. 3 is a schematic diagram illustrating an example of the data structure of the MAC/IP edit table according to the first embodiment. As illustrated in FIG. 3, the MAC/IP edit table 42 stores therein, in an associated manner, an output port 42a, a destination MAC address 42b, a destination IP address 42c, an input port 42d, a transmission source MAC address 42e, and a transmission source IP address 42f. The output port 42a corresponds to the output port of the VM 3 that is the transfer destination of a packet. The destination MAC address 42b is the MAC address of the VM 3 that is the transfer destination of the packet and corresponds to the MAC DA. The destination IP address 42c is the IP address of the VM 3 that is the transfer destination of the packet and corresponds to the DIP. The input port 42d corresponds to the input port of the VM 3 that is the transmission source of the packet. The transmission source MAC address 42e is the MAC address of the VM 3 that is the transmission source of the packet and corresponds to the MAC SA. The transmission source IP address 42f is the IP address of the VM 3 that is the transmission source of the packet and corresponds to the SIP. The output port 42a, the destination MAC address 42b, the destination IP address 42c, the input port 42d, the transmission source MAC address 42e, and the transmission source IP address 42f may also be previously stored in addition to the VMs 3 that are to be switched. Furthermore, the output port 42a, the destination MAC address 42b, and the destination IP address 42c are examples of a second association relationship. The input port 42d, the transmission source MAC address 42e, and the transmission source IP address 42f are examples of a third association relationship. The second association relationship and the third association relationship may also be stored in the same table or may also be stored in different tables.

As an example, if a packet is transferred from a wide area network (WAN) that is an external network to the VM 3, the VM switching unit 21 decides, based on the MAC/IP edit table 42, the destination MAC address and the destination IP address that are associated with the output port of the VM 3 that is the destination after the switching. Then, the VM switching unit 21 rewrites both the destination MAC address and the destination IP address that are included in the header of the received packet to the decided destination MAC address and the decided destination IP address and then transfers, to the switched VM 3, the packet in which both the addresses have been rewritten.

Furthermore, as another example, if a packet is transferred from the switched VM 3 to a WAN that is an external network, the VM switching unit 21 acquires, based on the MAC/IP edit table 42, the transmission source MAC address 42e and the transmission source IP address 42f that are associated with the input port 42d of the switched VM 3. Then, the VM switching unit 21 rewrites the acquired transmission source MAC address 42e and the transmission source IP address 42f to the MAC address and the IP address of the VM 3 that has not been switched. Thereafter, the VM switching unit 21 rewrites both the transmission source MAC address and the transmission source IP address that are included in the header of the packet to be received to the rewritten MAC address and the rewritten IP address and then transfers, to the WAN, the packet in which both the addresses have been rewritten.

A description will be given here by referring back to FIG. 1. The monitoring unit 30 includes the abnormality detecting unit 31.

The abnormality detecting unit 31 detects an abnormality of the VM 3 that is the transfer destination of a packet. The abnormality of the VM 3 mentioned here indicates the state in which a packet process is not able to be normally performed. For example, in the abnormality of the VM 3, a failure of the VM 3 or the VNF 4 or congestion of the network between the VM 3 and the VNF 4 is included.

### Example of a Process Performed before the Switching of the VM

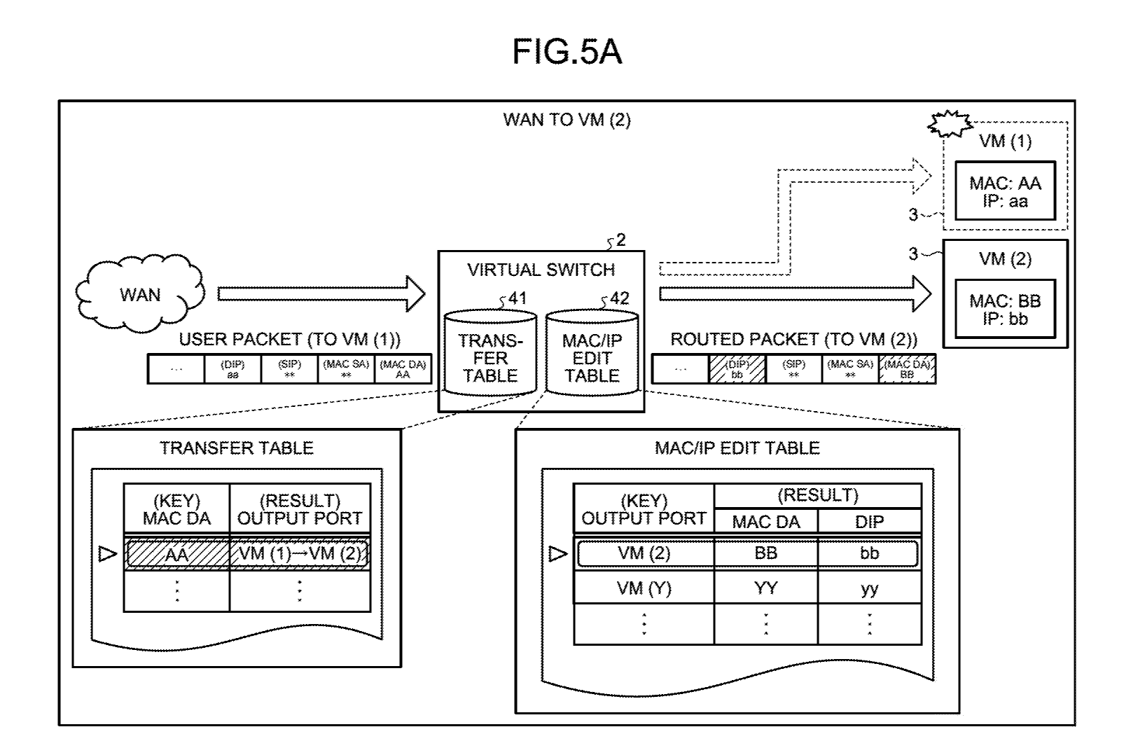

FIG. 4 is a schematic diagram illustrating an example of a process before the switching of VMs according to the first embodiment. Namely, a description will be given of a transfer process of a packet when the VM 3 that is an active system is normal.

The upper portion illustrated in FIG. 4 is the transfer process of the packet from the WAN that is the external network to the VM 3. The monitoring unit 30 in the virtual switch 2 determines that the VM 3 that is the transfer destination of the packet received from the WAN is normal. Then, the control unit 20 acquires, based on the transfer table 41, the output port associated with the destination MAC address of the received packet. The control unit 20 transfers the received packet to the VM 3 that is associated with the acquired output port. Here, the destination MAC address (MAC DA) of the received packet is “AA”. The control unit 20 acquires the output port associated with “AA” as “VM (1)” and transfers the received packet to the VM 3 that is associated with the output port of “VM (1)”. Namely, regarding the received packet, the control unit 20 writes “AA” as the destination MAC address (MAC DA) and “aa” as the destination IP address (DIP) and then transfers the received packet.

The lower portion illustrated in FIG. 4 is a transfer process of the packet from the VM 3 to the WAN. In also a case of transferring the packet from the VM 3 to the WAN, the virtual switch 2 similarly performs routing based on the transfer table 41. Namely, the control unit 20 acquires, based on the transfer table 41, the output port associated with the destination MAC address of the received packet. The control unit 20 transfers the received packet to the WAN associated with the acquired output port. Here, the destination MAC address (MAC DA) of the received packet is “**”. The control unit 20 acquires the output port associated with “**” as “WAN” and transfers the received packet to the WAN associated with the output port of “WAN”. Namely, regarding the received packet, the control unit 20 writes “AA” as the transmission source MAC address (MAC SA) and “aa” as the transmission source IP address (SIP) and then transfers the subject packet.

### Example of a Process Performed the VM is Switched

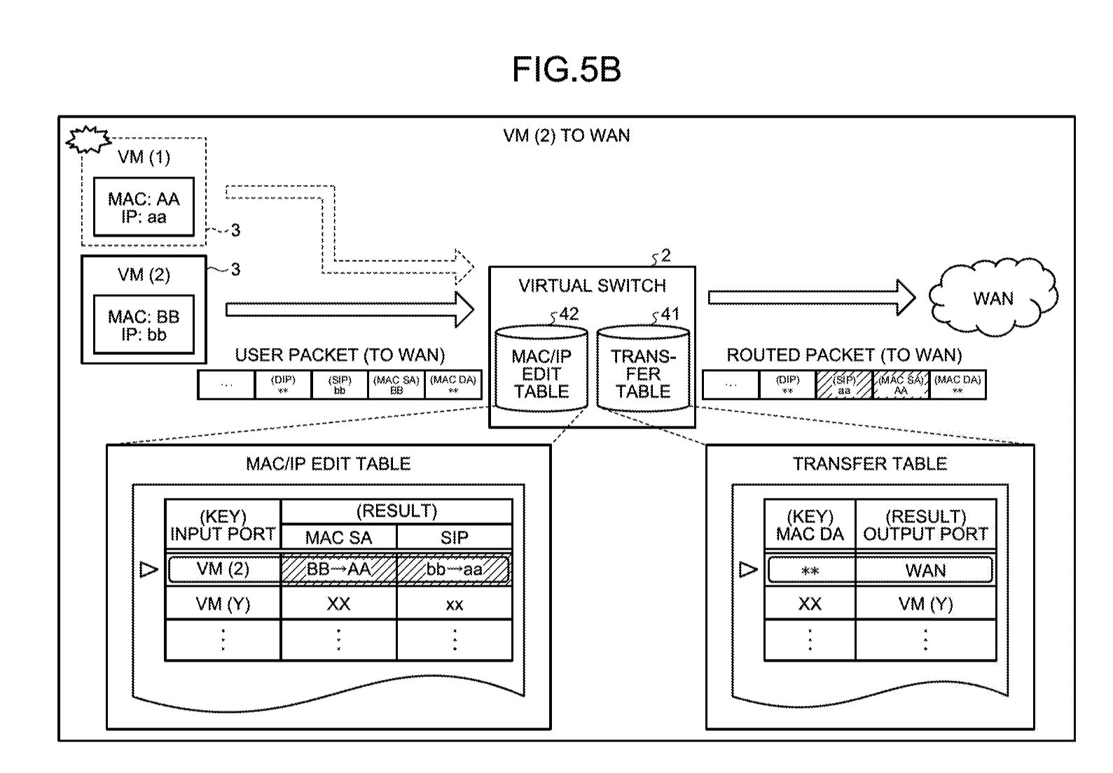

FIGS. 5A to 5C are schematic diagrams each illustrating an example of a VM switching process according to the first embodiment. Namely, a description will be given of a transfer process of a packet when the VM 3 that is an active system is abnormal.

In FIG. 5A, a description will be given of a VM switching process in a case in which, when a packet is transferred from the WAN that is the external network to the VM 3, the VM 3 that is the destination of the subject packet is abnormal. The abnormality detecting unit 31 in the virtual switch 2 determines that the VM 3 that is the transfer destination of the packet received from the WAN is abnormal. Then, if the VM 3 has been switched, the VM switching unit 21 rewrites the output port that is stored in the transfer table 41 and that is associated with the destination MAC address (MAC DA) of the received packet to the output port associated with the VM that is the new destination. Here, if the “VM (1)” is abnormal, the VM switching unit 21 rewrites the output port that is stored in the transfer table 41 and that is associated with the MAC DA of “AA” from the “VM (1)” to the “VM (2)”. Namely, it is assumed that the output port of the switched VM 3 is the “VM (2)”.

Then, the VM switching unit 21 decides, based on the MAC/IP edit table 42, the destination MAC address (MAC DA) and the destination IP address (DIP) that are associated with the output port associated with the switched destination VM 3. Here, from the MAC/IP edit table 42, “BB” is decided as the MAC DA and “bb” is decided as the DIP that are associated with the output port “VM (2)” that is associated with the destination VM 3 that has been switched.

Then, the VM switching unit 21 rewrites both the destination MAC address (MAC DA) and the destination IP address (DIP) that are included in the header of the packet to be received to the decided destination MAC address (MAC DA) and the decided destination IP address (DIP). Then, the VM switching unit 21 transfers, to the switched VM 3, the packet in which both the addresses have been rewritten. Here, the MAC DA of the packet to be transferred is rewritten from “AA” to “BB”. The DIP of the packet to be transferred is rewritten from “aa” to “bb”. Consequently, if an abnormality is present in the VM 3 that is the transfer destination of the packet, the virtual switch 2 detects an abnormality inside the virtual switch 2 and then switches the VM 3 in which an abnormality is present to the new VM 3; therefore, the virtual switch 2 can speed up the switching of the VMs 3.

In FIG. 5B, a description will be given of a VM switching process when a packet is transferred from the switched VM 3 to the WAN. When the VMs 3 have been switched, the VM switching unit 21 acquires, based on the MAC/IP edit table 42, the transmission source MAC address (MAC SA) and the transmission source IP address (SIP) that are associated with the input port 42d of the switched VM 3. Then, the VM switching unit 21 rewrites the acquired transmission source MAC address (MAC SA) and the transmission source IP address (SIP) to the MAC address and the IP address of the switched VM 3. Here, it is assumed that the input port of the switched VM 3 is the “VM (2)”. Then, regarding the MAC/IP edit table 42, the MAC SA associated with the input port “VM (2)” that corresponds to the switched VM 3 is rewritten from “BB” to “AA” that indicates the MAC address of the VM 3 that is before the switching. The SIP associated with the input port “VM (2)” that corresponds to the switched VM 3 is rewritten from “bb” to “aa” that indicates the IP address of the VM 3 that is before the switching.

Then, the VM switching unit 21 rewrites both the transmission source MAC address (MAC SA) and the transmission source IP address (SIP) that are included in the header of the packet received from the switched VM 3 to the rewritten MAC address and the rewritten IP address. Then, the VM switching unit 21 transfers, to the WAN, the packet in which both the addresses have been rewritten. Here, the MAC SA of the packet to be transferred is rewritten to “AA”. The SIP of the packet to be transferred is rewritten to “aa”. Consequently, even if an abnormality is present in the VM 3 that is the transfer destination of the packet that is transferred from the external network, by setting the transmission source of the return packet to the VM 3 that is before the switching, the virtual switch 2 can avoid confusion in communication between the external network and the VM 3. Namely, the external network can perform communication as if the external network communicates with the VM 3 that indicates the transfer destination that is set in the packet, i.e., the transfer destination that is before the switching.

Furthermore, in FIGS. 5A and 5B, a description has been given of a case in which the VM switching unit 21 switches, by using the VMs 3 created in the single server 1 as the target, the VM 3 that is the active system to the spare VM 3. However, the VM switching unit 21 is not limited to this and may also switches, by using the VM 3 created the other server 1 as the target, the VM 3 that is the active system to the spare VM 3.

In FIG. 5C, a description will be given of a VM switching process in a case in which, when a packet is transferred from the WAN that is the external network to the VM 3, the VM 3 that is the destination of the subject packet is abnormal. The abnormality detecting unit 31 in the virtual switch 2 determines that the VM 3 that is the transfer destination of the packet received from the WAN is abnormal. Then, the VM switching unit 21 rewrites the output port that is stored in the transfer table 41 and that is associated with the destination MAC address (MAC DA) of the received packet to the output port associated with the VM that is the new destination. Here, if the “VM (B)” is abnormal, the VM switching unit 21 rewrites the output port that is stored in the transfer table 41 and that is associated with the MAC DA of “BB” from “VM (B)” to “VM (C)”. Namely, the output port of the switched VM 3 is rewritten to the “VM (C)” that is included in the other server 1′.

Then, the VM switching unit 21 decides, based on the MAC/IP edit table 42, the destination MAC address (MAC DA) and the destination IP address (DIP) associated with the output port that is the switched destination VM 3. Here, from the MAC/IP edit table 42, “CC” is decided as the MAC DA and “cc” is decided as the DIP associated with the output port “VM (C)” of the switched destination VM 3.

Then, the VM switching unit 21 rewrites both the destination MAC address (MAC DA) and the destination IP address (DIP) that are included in the header of the packet to be received to the decided destination MAC address (MAC DA) and the decided destination IP address (DIP). Then, the VM switching unit 21 transfers, to the switched VM 3, the packet in which both the addresses have been rewritten. Here, the MAC DA of the packet to be transferred is rewritten from “BB” to “CC”. The DIP of the packet to be transferred is rewritten from “bb” to “cc”. Consequently, if an abnormality is present in the VM 3 that is the transfer destination of the packet, the virtual switch 2 detects an abnormality inside the virtual switch 2 and switches the VM 3 in which an abnormality is present to the new VM 3; therefore, even if the switching destination is the other server 1′, the virtual switch 2 can speed up the switching of the VMs 3.

Flowchart of the VM Switching Process

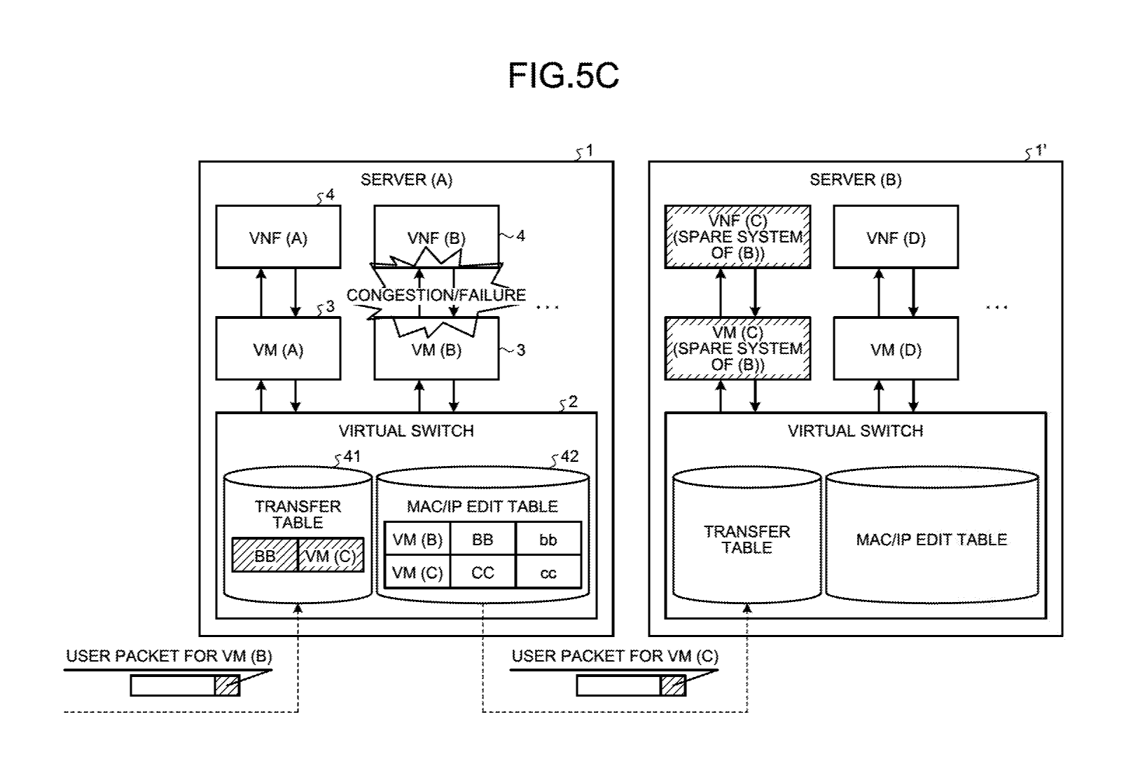

In the following, the flowchart of the VM switching process according to the first embodiment will be described with reference to FIG. 6. FIG. 6 is a flowchart illustrating an example of the flow of the VM switching process according to the first embodiment.

As illustrated in FIG. 6, the abnormality detecting unit 31 determines whether an abnormality of the VM 3 has been detected (Step S11). If it is determined that no abnormality of the VM 3 is detected (No at Step S11), the abnormality detecting unit 31 ends the VM switching process.

In contrast, if it is determined that an abnormality of the VM 3 has been detected (Yes at Step S11), the VM switching unit 21 determines whether the packet is transferred from the WAN to the VM 3 (Step S12). If it is determined that the packet is transferred from the WAN to the VM 3 (Yes at Step S12), the VM switching unit 21 performs the process of transferring the packet from the WAN to the VM 3 (Step S13). Furthermore, the flowchart of the process of transferring the packet from the WAN to the VM 3 will be described later. Then, if the process has been completed, the VM switching unit 21 ends the VM switching process.

In contrast, if it is determined that the packet is not transferred from the WAN to the VM 3 (No at Step S12), the VM switching unit 21 performs the process of transferring the packet from the VM 3 to the WAN (Step S14). Furthermore, the process of transferring the packet from the VM 3 to the WAN will be described later. Then, if the process has been completed, the VM switching unit 21 ends the VM switching process.

Flowchart of the VM Switching Process When Transferring from the WAN to the VM

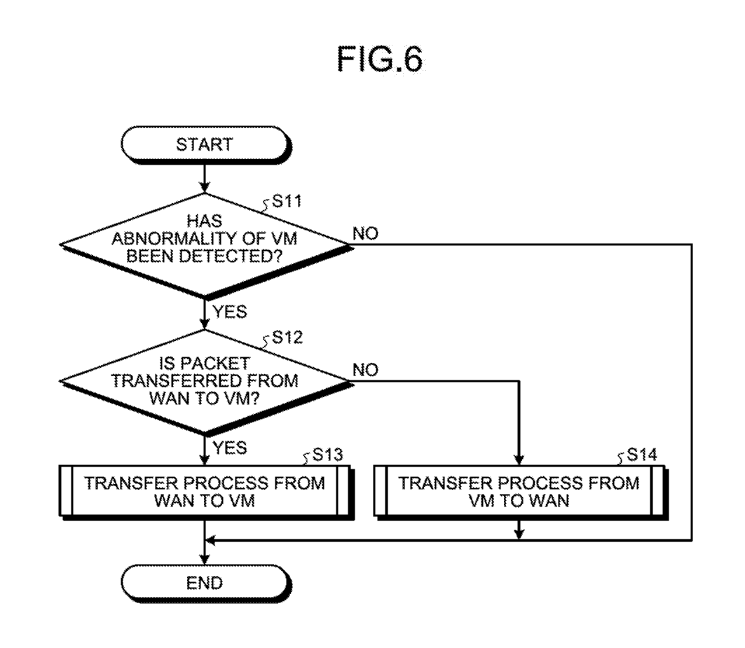

In the following, the flowchart of the VM switching process when transferring from the WAN to the VM 3 according to the first embodiment will be described with reference to FIG. 7. FIG. 7 is a flowchart illustrating an example of the flow of the VM switching process when transferring from a WAN to a VM.

As illustrated in FIG. 7, the VM switching unit 21 performs an update process of the transfer table 41 by using the received packet (Step S31). Furthermore, the flowchart of the update process of the transfer table 41 will be described later.

The VM switching unit 21 acquires the output port from the transfer table 41 by using the destination MAC address (MAC DA) of the received packet (Step S32). Then, the VM switching unit 21 acquires edit information from the MAC/IP edit table 42 by using the acquired output port (Step S33). The edit information mentioned here is the destination MAC address (MAC DA) and the destination IP address (DIP) associated with the output port.

Then, the VM switching unit 21 rewrites, by using the edit information, the destination MAC address (MAC DA) and the destination IP address (DIP) of the received packet (Step S34). Namely, the VM switching unit 21 rewrites the MAC DA and the DIP of the received packet to the MAC address and the IP address of the switched new VM 3.

Then, the VM switching unit 21 transfers, to the new VM 3, the packet in which the addresses have been rewritten (Step S35). Then, the VM switching unit 21 ends the VM switching process to be performed when the VM switching unit 21 transfers the packet from the WAN to the VM 3.

Flowchart of the Update Process of the Transfer Table

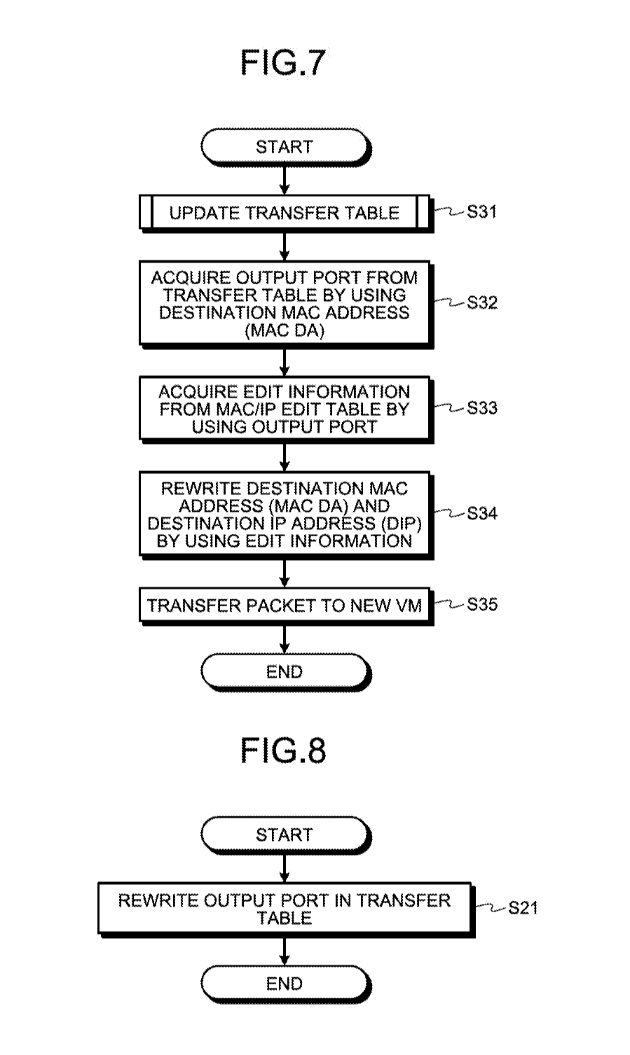

In the following, the flowchart of the update process of the transfer table 41 according to the first embodiment will be described with reference to FIG. 8. FIG. 8 is a flowchart illustrating an example of the flow of an update process of the transfer table.

As illustrated in FIG. 8, the VM switching unit 21 rewrites the output port in the transfer table 41 (Step S21). For example, the VM switching unit 21 rewrites the output port that is stored in the transfer table 41 and that is associated with the destination MAC address (MAC DA) of the received packet to the output port of the new VM 3.

Flowchart of the VM Switching when Transferring from the VM to the WAN

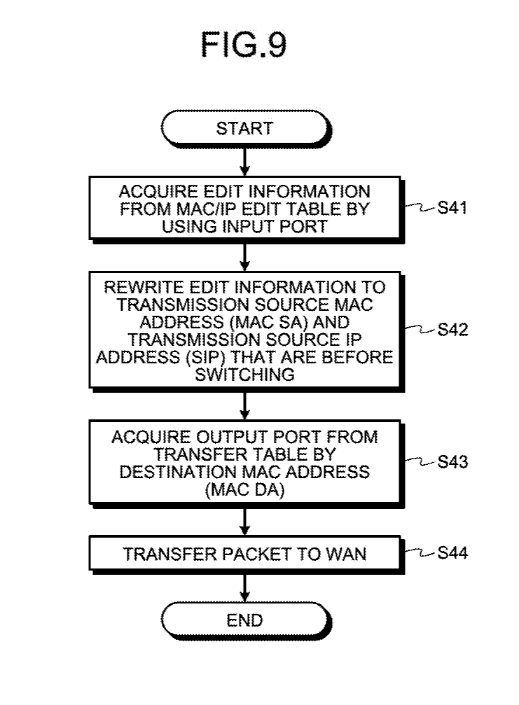

In the following, the flowchart of the VM switching process when transferring from the VM 3 to the WAN according to the first embodiment will be described with reference to FIG. 9. FIG. 9 is a flowchart illustrating an example of the flow of the VM switching process when transferring from a WAN to a VM.

As illustrated in FIG. 9, the VM switching unit 21 acquires, by using the input port of the received packet, edit information from the MAC/IP edit table 42 (Step S41). The edit information mentioned here is the transmission source MAC address (MAC SA) and the transmission source IP address (SIP) associated with the input port.

Then, the VM switching unit 21 rewrites the edit information to the transmission source MAC address (MAC SA) and the transmission source IP address (SIP) of the VM 3 that is before the switching (Step S42). For example, the VM switching unit 21 rewrites the edit information that is stored in the MAC/IP edit table 42 and that is associated with the input port of the received packet to the MAC SA and the SIP of the VM 3 that is before the switching. In addition, the VM switching unit 21 rewrites the MAC SA and the SIP of the received packet to the MAC SA and the SIP of the VM 3 that is before the switching. Namely, the VM switching unit 21 rewrites the addresses as if the WAN has received the packet from the VM 3 that has not been switched and that was active system before.

Then, the VM switching unit 21 acquires the output port from the transfer table 41 by using the destination MAC address (MAC DA) of the received packet (Step S43). Then, the VM switching unit 21 transfers, to the WAN by using the acquired output port, the packet in which the addresses have been rewritten (Step S44). Then, the VM switching unit 21 ends the VM switching process performed when transferring from the VM 3 to the WAN.

### Effect of the First Embodiment

According to the first embodiment described above, the virtual switch 2 detects an abnormality of the VM 3 that is the transfer destination of a packet. Then, if the VMs 3 have been switched, the virtual switch 2 rewrites the transfer table 41 containing the MAC address of the transfer destination and the port number of the VM 3 that is before the switching to the transfer table 41 containing the subject MAC address and the port number of the VM 3 that is after the switching. The virtual switch 2 performs the following process based on the rewritten transfer table 41 and based on the MAC/IP edit table 42 that stores therein the port number of the VM 3 at the transfer destination that is after the switching, the transfer destination MAC address, and the transfer destination IP address. Namely, the virtual switch 2 decides, from the matched port number, the transfer destination MAC address and the transfer destination IP address of the switched VM 3. The virtual switch 2 rewrites both the transfer destination MAC address and the transfer destination IP address that are included in the header of the packet received from the external network to the decided MAC address and the decided IP address. Then, the virtual switch 2 transfers the rewritten packet to the switched VM 3. With this configuration, if an abnormality is present in the VM 3 that is the transfer destination of the packet, the virtual switch 2 detects an abnormality inside the virtual switch 2 and switches the VM 3 in which an abnormality is present to the new VM 3; therefore, the virtual switch 2 can speed up the switching of the VMs 3. In particular, in voice packet communication in which a real-time operation is desired, it is requested that the time needed for the switching be equal to or less than, for example, 50 milliseconds; however, by speeding up the time needed for the virtual switch 2 to perform the switching, the quality of voice can be improved. Furthermore, by rewriting the transfer table 41 to the port number of the switched VM 3, even if the virtual switch 2 receives the packet addressed to the same transfer destination next time, the virtual switch 2 can smoothly transfer the subject packet to the switched VM 3.

Furthermore, according to the first embodiment, when the VMs 3 have been switched, the virtual switch 2 performs the following process. Namely, the virtual switch 2 rewrites a third association relationship among the port number of the switched VM 3, the transfer source MAC address that is after the switching, and the transfer source IP address that is after the switching to the third association relationship among the port number of the switched VM, the transfer source MAC address that is before the switching, and the transfer source IP address that is before the switching. The virtual switch 2 rewrites, based on the rewritten third association relationship, both the transfer source MAC address and the transfer source IP address that are included in the header of the packet transferred from the switched VM 3 to both the rewritten MAC address and the rewritten IP address. Then, the virtual switch 2 transfers the rewritten packet to an external network. With this configuration, even if an abnormality is present in the VM 3 that is the transfer destination of the packet that has been transferred from an external network, by using the transmission source of the return packet as the VM 3 that is before the switching, the virtual switch 2 can avoid confusion in communication between the external network and the VM 3.

### [b] Second Embodiment

Incidentally, in the server 1 according to the first embodiment, the virtual switch 2 detects an abnormality of the VM 3 that is the transfer destination of a packet and switches, to the new VM 3, the VM 3 in which an abnormality has been detected. However, in the server 1, the embodiment is not limited to this and the virtual switch 2 may also detect an abnormality of the VM 3 that is the transfer destination pf a packet based on the sequential checking of a plurality of packets transferred to the VM 3.

Thus, in the second embodiment, a description will be given of a case in which the virtual switch 2 detects an abnormality of the VM 3 that is the transfer destination of a packet on the basis of sequential checking of the packets transferred to the VM 3.

### Configuration of a Server according to the Second Embodiment

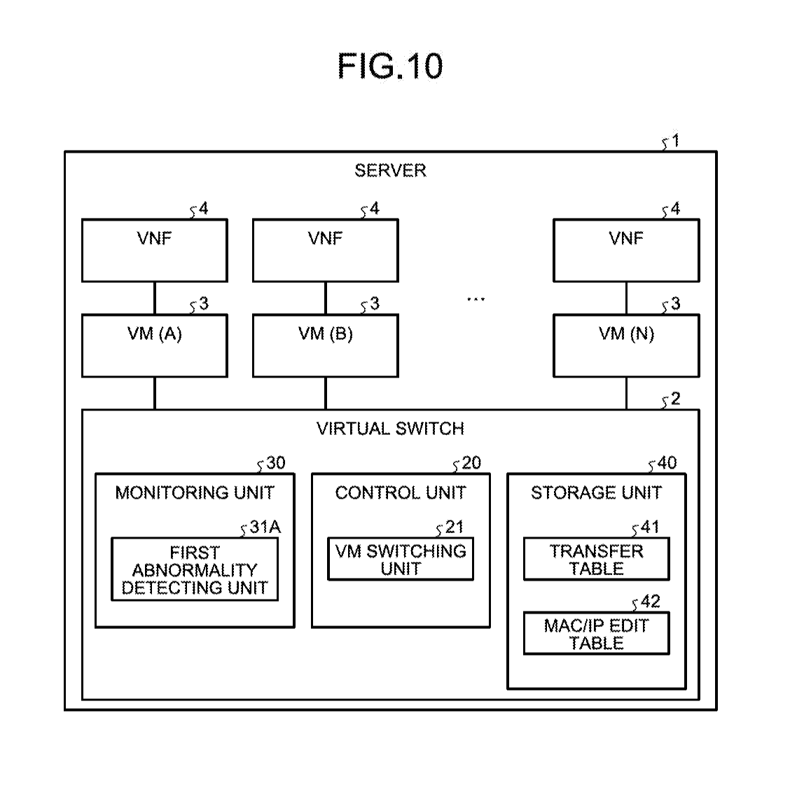

FIG. 10 is a block diagram illustrating the functional configuration of the server according to the second embodiment. Furthermore, by assigning the same reference numerals to components having the same configuration as those in the server 1 according to the first embodiment illustrated in FIG. 1, overlapped configurations and operations thereof will be omitted. The second embodiment differs from the first embodiment in that the abnormality detecting unit 31 is changed to a first abnormality detecting unit 31A.

The first abnormality detecting unit 31A detects an abnormality of the VM 3 based on the sequence of the packets that are transferred to the VM 3 and the sequence of the packets that are returned from the VM 3. For example, the first abnormality detecting unit 31A compares the sequence of the packets when the packets are transferred to the VM 3 with the sequence of the packets that are returned from the VM 3 and determines, if the sequences are different, that an abnormality has occurred in the VM 3. However, even if the sequences are different, there may be a case in which a packet is intentionally or accidentally discarded in the VM 3. An example of the packet intentionally being discarded includes a packet that does not request a response. An example of the packet accidentally being discarded includes a packet loss due to a failure of or congestion in the VM 3. In such a case, the first abnormality detecting unit 31A determines whether discard information on the immediately previous packet is included in the subsequent packet that is sent back from the VM 3 and, if the subject information is not included, that an abnormality has occurred in the VM 3. Namely, the first abnormality detecting unit 31A determines that congestion or a failure has occurred in the VM 3.

### Example of an Abnormality Detecting Process

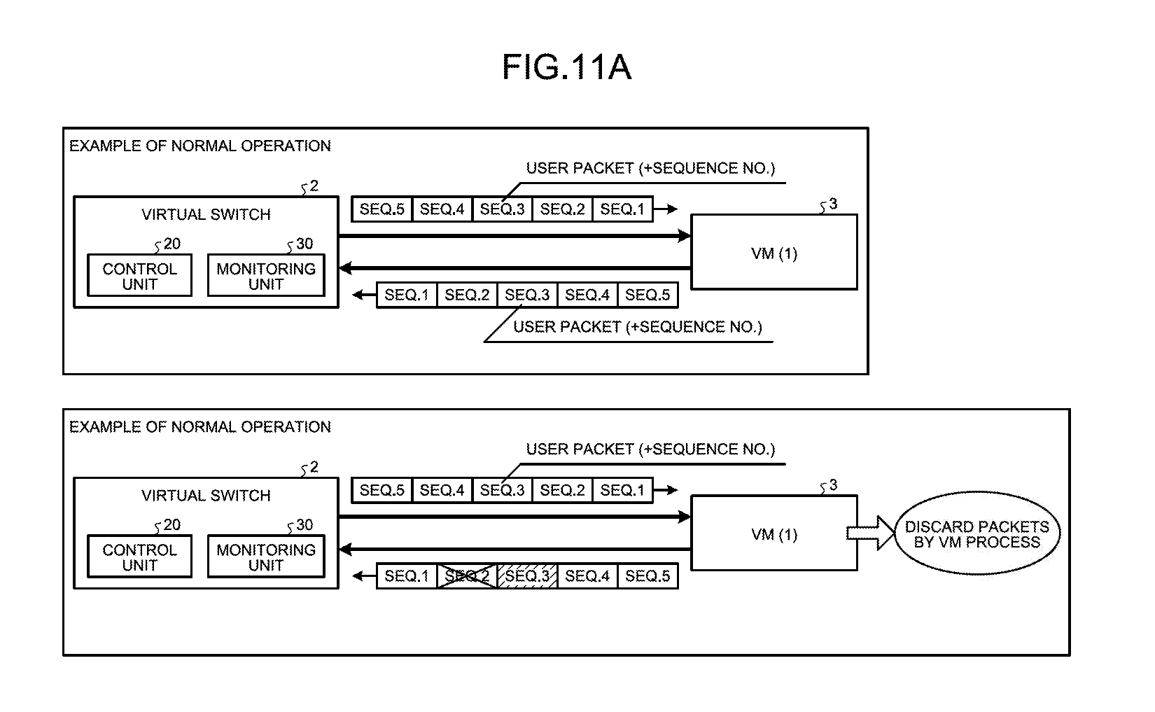

In the following, an example of an abnormality detecting process according to the second embodiment will be described with reference to FIGS. 11A and 11B. In FIG. 11A, the normal operation of the abnormality detecting process will be described. In FIG. 11B, abnormality detection performed in the abnormality detecting process will be described.

As illustrated in the upper portion of FIG. 11A, the first abnormality detecting unit 31A compares the sequence of the packets to be transmitted to the VM 3 with the sequence of the packets sent back from the VM 3 and determines, if both the sequences are not different, that no abnormality occurs in the VM 3. Here, it is assumed that sequence numbers are added to the packet. The sequence of the sequence numbers of the packets to be transmitted to the VM 3 is 1, 2, 3, 4, and 5. The sequence of the sequence numbers of the packets sent back from the VM 3 is 1, 2, 3, 4, and 5. Thus, because the sequences of the sequence numbers are not different, the first abnormality detecting unit 31A determines that no abnormality occurs in the VM 3.

As illustrated in the lower portion of FIG. 11A, if both the sequences are different, the first abnormality detecting unit 31A determines whether the discard information on immediately previous packet is included in the packet that has been sent back from the VM 3 next time and determines, if the discard information is included, that no abnormality occurs in the VM 3. Here, the sequence of the sequence numbers of the packets transmitted to the VM 3 is 1, 2, 3, 4, and 5. The sequence of the sequence numbers of the packets sent back from the VM 3 is 1, 3, 4, and 5. Namely, the packet with the sequence number of 2 is omitted. However, because the discard information on the packet with the sequence number of 2 is included in the subsequent packet with the sequence number of 3, the first abnormality detecting unit 31A determines that no abnormality occurs in the VM 3.

As illustrated in FIG. 11B, if the sequences are different, the first abnormality detecting unit 31A determines whether the discard information on the immediately previous packet is included in the subsequent packet that is sent back from the VM 3 next time and determines, if the discard information is not included, an abnormality has occurred in the VM 3. Here, the sequence of the sequence numbers of the packets to be transmitted to the VM 3 is 1, 2, 3, 4, and 5. The sequence of the sequence numbers of the packets sent back from the VM 3 is 1, 3, 4, and 5. Namely, the packet with the sequence number of 2 is omitted. However, because the discard information on the packet with the sequence number of 2 is not included in the packet with the subsequent sequence number of 3, the first abnormality detecting unit 31A determines that an abnormality has occurred in the VM 3.

Thus, the VM switching unit 21 in the control unit 20 switches the VM 3 that is determined an abnormality has occurred to the spare VM 3.

Flowchart of the Abnormality Detecting Process

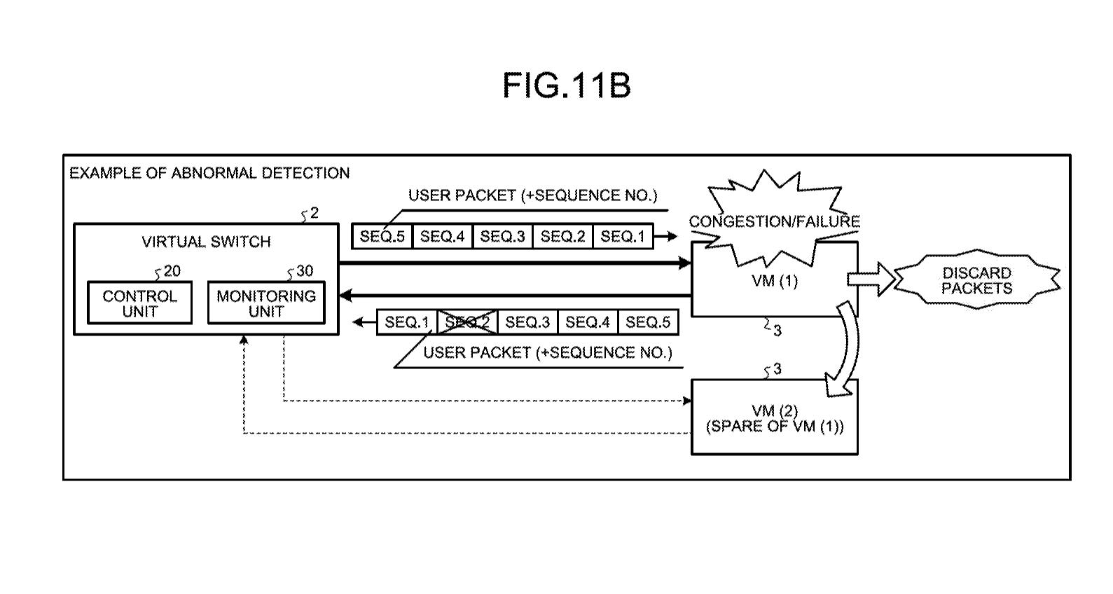

In the following, the flowchart of the abnormality detecting process according to the second embodiment will be described with reference to FIG. 12. FIG. 12 is a flowchart illustrating an example of the flow of the abnormality detecting process according to the second embodiment. Furthermore, it is assumed that the first abnormality detecting unit 31A holds the sequence numbers of the packets transmitted to the VM 3 (hereinafter, referred to as a transmission sequence number) in a switch counter. If a plurality of packets is continuously transmitted, in the switch counter, the transmission sequence numbers are sequentially held.

As illustrated in FIG. 12, the first abnormality detecting unit 31A acquires the transmission sequence numbers from the switch counter (Step S51). The first abnormality detecting unit 31A acquires the reception sequence numbers from the received packets (Step S52).

The first abnormality detecting unit 31A determines whether the transmission sequence numbers and the reception sequence numbers match (Step S53). If it is determined that the transmission sequence number and the reception sequence number match (Yes at Step S53), the first abnormality detecting unit 31A acquires the reception sequence number from the packet that is received from the VM 3 next time (Step S54). This is a case in which the first abnormality detecting unit 31A determines that no abnormality occurs in the VM 3. Then, the first abnormality detecting unit 31A acquires the subsequent transmission sequence number from the switch counter (Step S55) and proceeds to Step S53 in order to perform the subsequent comparison process.

In contrast, if it is determined that the transmission sequence number reception sequence number do not match (No Step S53), the first abnormality detecting unit 31A acquires the reception sequence number from the packet that is subsequently received (Step S56). Then, the first abnormality detecting unit 31A determines whether, in the packet with the acquired reception sequence number, the discard information on the packet with the reception sequence number that is immediately before the subject packet is included (Step S57).

If it is determined that the discard information is included (Yes at Step S57), the first abnormality detecting unit 31A proceeds to Step S55. This is the case in which the first abnormality detecting unit 31A determines that no abnormality occurs in the VM 3.

In contrast, if it is determined that the discard information is not included (No at Step S57), the first abnormality detecting unit 31A allows the VM switching unit 21 to perform the switching process on the VM 3 (Step S58). Then, the first abnormality detecting unit 31A ends the abnormality detecting process.

Flowchart on the VM Side

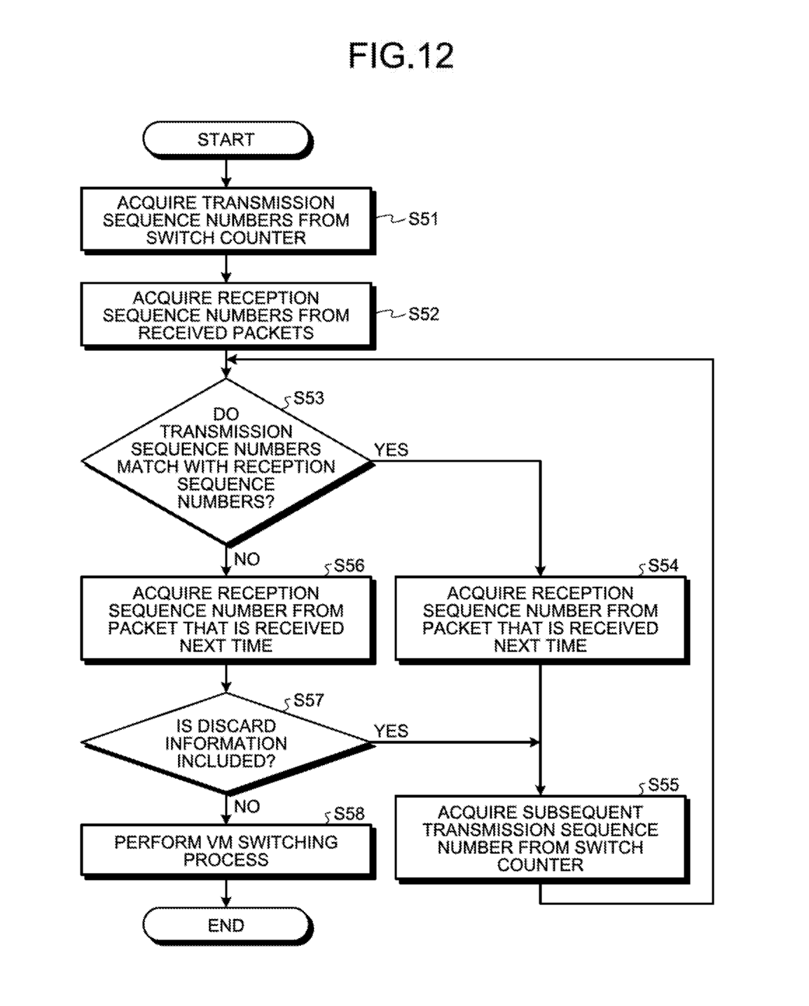

In the following, an example of the flowchart of a process performed on the VM 3 side according to the second embodiment will be described with reference to FIG. 13. FIG. 13 is a flowchart illustrating an example of the flow of the process performed on the VM side according to the second embodiment. Furthermore, it is assumed that the VM 3 that is the active system receives a user packet transmitted from the virtual switch 2.

As illustrated in FIG. 13, the VM 3 acquires the transmission sequence number from the user packet (Step S61). The VM 3 determines whether the user packet is to be discarded (Step S62). If it is determined that the user packet is not discarded (No at Step S62), the VM 3 proceeds to Step S64.

In contrast, if it is determined that the user packet is to be discarded (Yes at Step S62), the VM 3 sets the discard information to the user packet with the subsequent sequence number (Step S63). Then, the VM 3 proceeds to Step S64.

At Step S64, the VM 3 transmits the user packet to the VNF 4 (Step S64).

### Effect of the Second Embodiment

According to the second embodiment described above, the virtual switch 2 detects an abnormality of the VM 3 based on the sequence of the packets when transferring the packets to the VM 3 and based on the sequence of the packets that are sent back from the VM 3. Then, the virtual switch 2 switches the VM 3 in which the abnormality has been detected to the new VM 3. With this configuration, by using the sequences of the packets that are transmitted and received, the virtual switch 2 detects an abnormality of the VM 3 and switches the VM 3 in which the abnormality has been detected to the new VM 3, whereby the virtual switch 2 can improve the quality of communication.

### [c] Third Embodiment

Incidentally, in the server 1 according to the first embodiment, the virtual switch 2 detects an abnormality of the VM 3 that is the transfer destination of the packet and switches the VM 3 in which the abnormality has been detected to the new VM 3. In the server 1 according to the second embodiment, the virtual switch 2 detects an abnormality of the VM 3 that is the transfer destination of the packet by checking the sequence of the plurality of packets to be transferred to the VM 3. However, in the server 1, the embodiments are not limited to these and the virtual switch 2 may also insert the input packets into a queue and detect an abnormality of the VM 3 based on the number of packets that are not extracted from the queue.

Thus, in the third embodiment, a description will be given of a case in which the virtual switch 2 inserts the input packet into a queue and detects an abnormality of the VM 3 based on the number of packets that are not extracted from the queue.

### Configuration of the Server according to the Third Embodiment

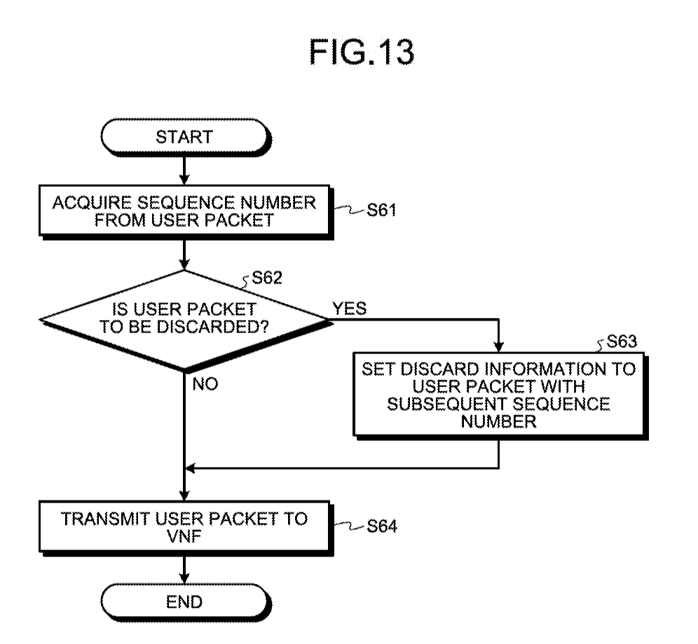

FIG. 14 is a block diagram illustrating the functional configuration of the server according to the third embodiment. Furthermore, by assigning the same reference numerals to components having the same configuration as those in the server 1 according to the second embodiment illustrated in FIG. 10, overlapped configurations and operations thereof will be omitted. The third embodiment differs from the second embodiment in that a second abnormality detecting unit 31B is added.

The second abnormality detecting unit 31B inserts the input packet into a queue and detects an abnormality of the VM 3 based on the number of packets that are not extracted from the queue. For example, the second abnormality detecting unit 31B sequentially inserts the input packets into the queue. If the number of packets that are not extracted from the queue is equal to or greater than a first threshold, the second abnormality detecting unit 31B determines that an abnormality has occurred in the VM 3. Namely, the second abnormality detecting unit 31B determines that congestion or a failure has occurred in the VM 3. Furthermore, the first threshold is previously examined by an experiment or the like and the obtained information is stored in the storage unit 40.

### Example of the Abnormality Detecting Process

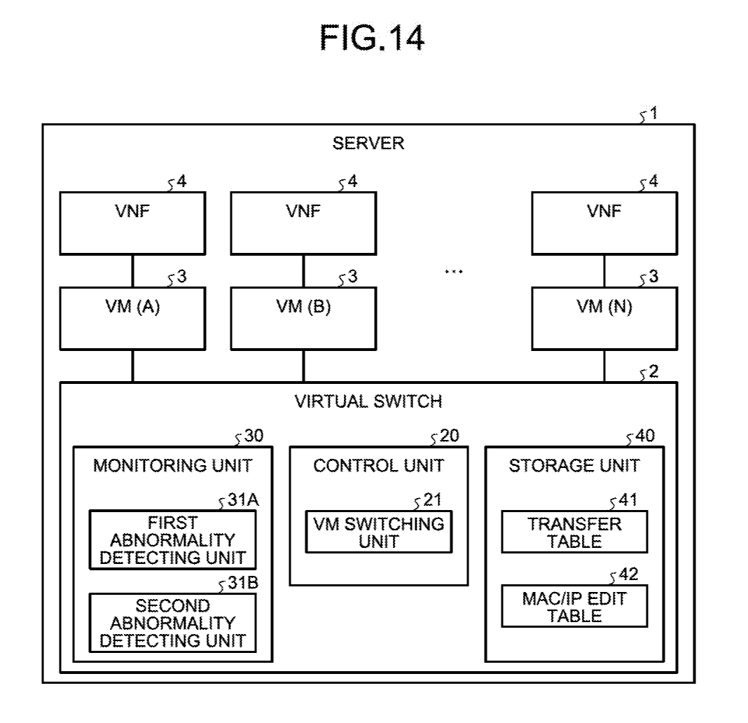

In the following, an example of the abnormality detecting process according to the third embodiment will be described with reference to FIG. 15. In the upper portion illustrated in FIG. 15, the normal operation of the abnormality detecting process will be described. In the lower portion illustrated in FIG. 15, abnormality detection performed in the abnormality detecting process will be described.

As illustrated in the upper portion of FIG. 15, the second abnormality detecting unit 31B inserts the input packets into the queue and determines, if the number of packets that are not extracted from the queue is less than the first threshold, that no abnormality occurs in the VM 3. Here, it is assumed that the first threshold is 4. The packets inserted into the queue are A, B, and C. Thus, because the number of packets that are not extracted from the queue is 3 and is smaller than the first threshold of 4, the second abnormality detecting unit 31B determines that no abnormality occurs in the VM 3.

As illustrated in the lower portion of FIG. 15, the second abnormality detecting unit 31B inserts the input packets into the queue and determines, if the number of packets that are not extracted from the queue is equal to or greater than the first threshold, that an abnormality has occurred in the VM 3. Here, it is assumed that the first threshold is 4. The packets inserted into the queue are A, B, C, and D. Thus, because the number of packets that are not extracted from the queue is 4 and is equal to or greater than the first threshold of 4, the second abnormality detecting unit 31B determines that an abnormality has occurred in the VM 3.

Thus, the VM switching unit 21 in the control unit 20 switches the VM 3 in which it is determined that an abnormality has occurred to the spare VM 3.

Flowchart of the Abnormality Detecting Process

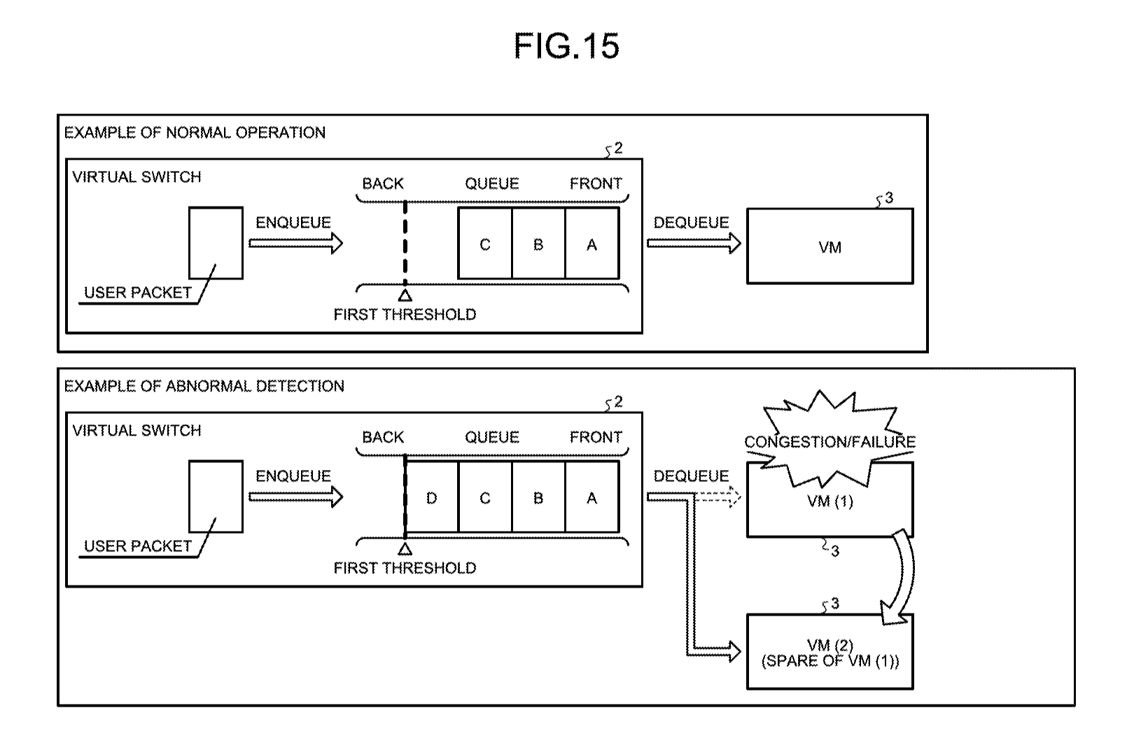

In the following, the flowchart of the abnormality detecting process according to the third embodiment will be described with reference to FIG. 16. FIG. 16 is a flowchart illustrating an example of the flow of the abnormality detecting process according to the third embodiment. Furthermore, it is assumed that the second abnormality detecting unit 31B sequentially inserts the input packets to the queue.

As illustrated in FIG. 16, the second abnormality detecting unit 31B acquires a queue length from the queue (Step S71). For example, the second abnormality detecting unit 31B acquires the number of packets that are not extracted from the queue as a queue length.

Then, the second abnormality detecting unit 31B determines whether the queue length is equal to or greater than the first threshold (Step S72). If it is determined that the queue length is less than the first threshold (No at Step S72), the second abnormality detecting unit 31B transmits the packet to the VM 3 (Step S73). Then, the second abnormality detecting unit 31B ends the abnormality detecting process.

In contrast, if it is determined that the queue length is equal to or greater than the first threshold (Yes at Step S72), the second abnormality detecting unit 31B allows the VM switching unit 21 to perform the switching process on the VM 3 (Step S74). Then, the second abnormality detecting unit 31B ends the abnormality detecting process.

### Effect of the Third Embodiment

According to the third embodiment described above, the virtual switch 2 inserts the input packet into the queue and detects an abnormality of the VM 3 based on the number of packets that are not extracted from the queue. Then, the virtual switch 2 switches the VM 3 in which the abnormality has been detected to the new VM 3. With this configuration, the virtual switch 2 detects an abnormality of the VM 3 by using the number of packets that are not extracted from the queue and then switches the VM 3 in which the abnormality has been detected to the new VM 3, whereby the virtual switch 2 can improve the quality of communication.

### [d] Fourth Embodiment

Incidentally, in the server 1 according to the first embodiment, the virtual switch 2 detects an abnormality of the VM 3 that is the transfer destination of the packet and switches the VM 3 in which the abnormality has been detected to the new VM 3. In the server 1 according to the second embodiment, the virtual switch 2 detects an abnormality of the VM 3 that is the transfer destination of the packet by checking the sequence of a plurality of packets that are transferred to the VM 3. In the server 1 according to the third embodiment, the virtual switch 2 inserts the input packets into a queue and detects an abnormality of the VM 3 based on the number of packets that are not extracted from the queue. However, in the server 1, the embodiments are not limited to these and the virtual switch 2 may also detect an abnormality of the VM 3 based on the number of packets discarded by the VM 3.

Thus, in a fourth embodiment, a description will be given of a case in which the virtual switch 2 detects an abnormality of the VM 3 based on the number of packets discarded by the VM 3.

### Configuration of the Server according to the Fourth Embodiment

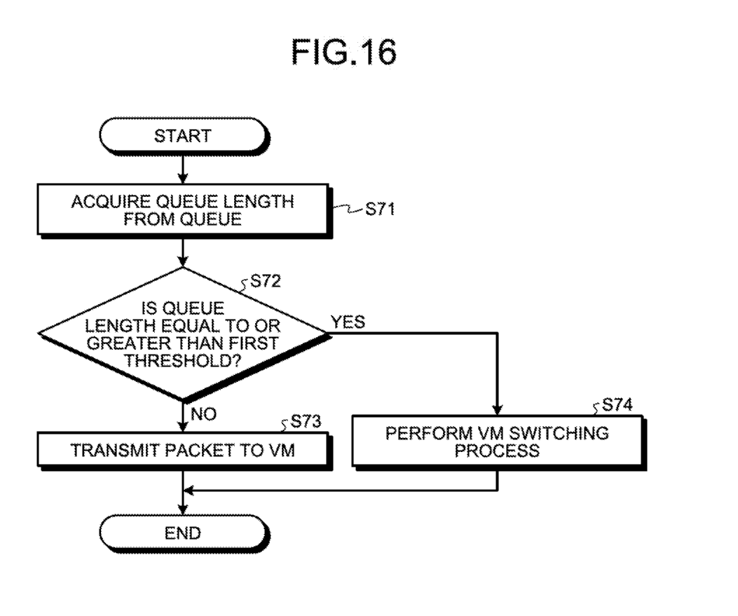

FIG. 17 is a block diagram illustrating the functional configuration of the server according to the fourth embodiment. Furthermore, by assigning the same reference numerals to components having the same configuration as those in the server 1 according to the third embodiment illustrated in FIG. 14, overlapped configurations and operations thereof will be omitted. The fourth embodiment differs from the third embodiment in that a third abnormality detecting unit 31C is added.

The third abnormality detecting unit 31C detects an abnormality of the VM 3 based on the number of discards of the packets discarded by the VM 3. For example, if the number of discards of the packets discarded by the VM 3 is equal to or greater than a second threshold, the third abnormality detecting unit 31C determines that an abnormality has occurred in the VM 3. Namely, the third abnormality detecting unit 31C determines that congestion or a failure has occurred in the VM 3. Furthermore, the number of discards of the discarded packets is set in, for example, a response monitoring packet that is a response to the monitoring packet transferred from the third abnormality detecting unit 31C. Furthermore, the second threshold is previously examined by an experiment or the like and the obtained information is stored in the storage unit 40.

### Example of the Abnormality Detecting Process

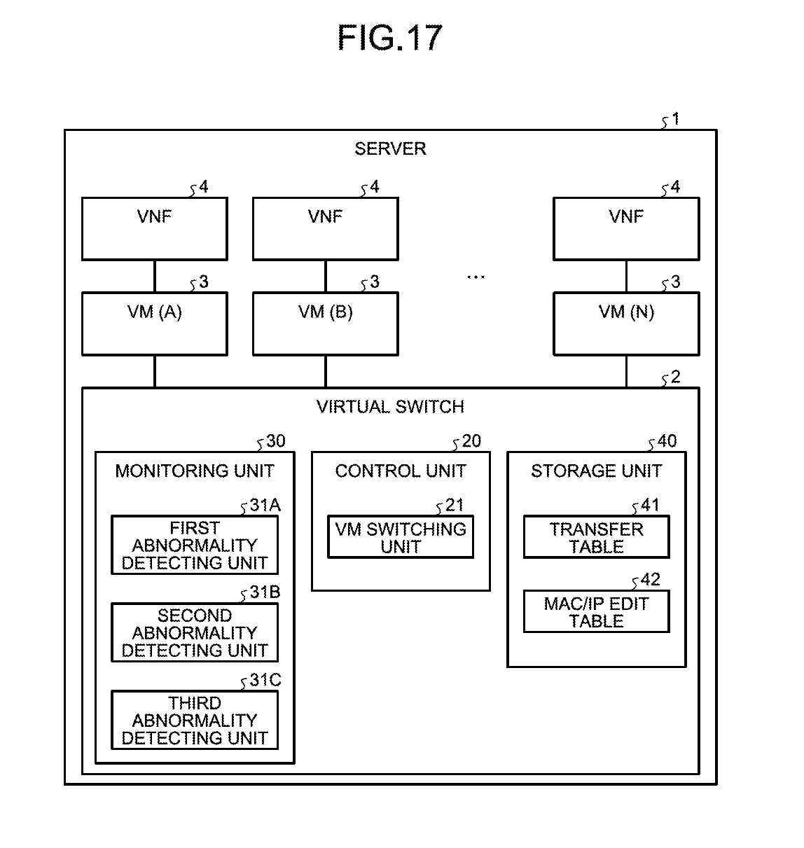

In the following, an example of the abnormality detecting process according to the fourth embodiment will be described with reference to FIG. 18. In the upper portion of FIG. 18, the normal operation of the abnormality detecting process will be described. In the lower portion of FIG. 18, abnormality detection of the abnormality detecting process will be described.

As illustrated in the upper portion of FIG. 18, if the number of discards of the packets discarded by the VM 3 is less than the second threshold, the third abnormality detecting unit 31C determines that no abnormality occurs in the VM 3. Here, it is assumed that the second threshold is a predetermined value that is equal to or greater than zero. If the number of discards of the packets discarded by the VM 3 is zero, because the number of discards of the packets discarded by the VM 3 is less than the second threshold, the third abnormality detecting unit 31C determines that no abnormality occurs in the VM 3.

As illustrated in the lower portion of FIG. 18, if the number of discards of the packets discarded by the VM 3 is equal to or greater than the second threshold, the third abnormality detecting unit 31C determines that an abnormality has occurred in the VM 3. Here, it is assumed that the number of discards of the packets discarded by the VM 3 is set in the monitoring packet as the discard information. If the number of discards is equal to or greater than the second threshold, the third abnormality detecting unit 31C determines that an abnormality has occurred in the VM 3.

Thus, the VM switching unit 21 in the control unit 20 switches the VM 3 in which it is determined that an abnormality has occurred to the spare VM 3.

Flowchart of the Abnormality Detecting Process

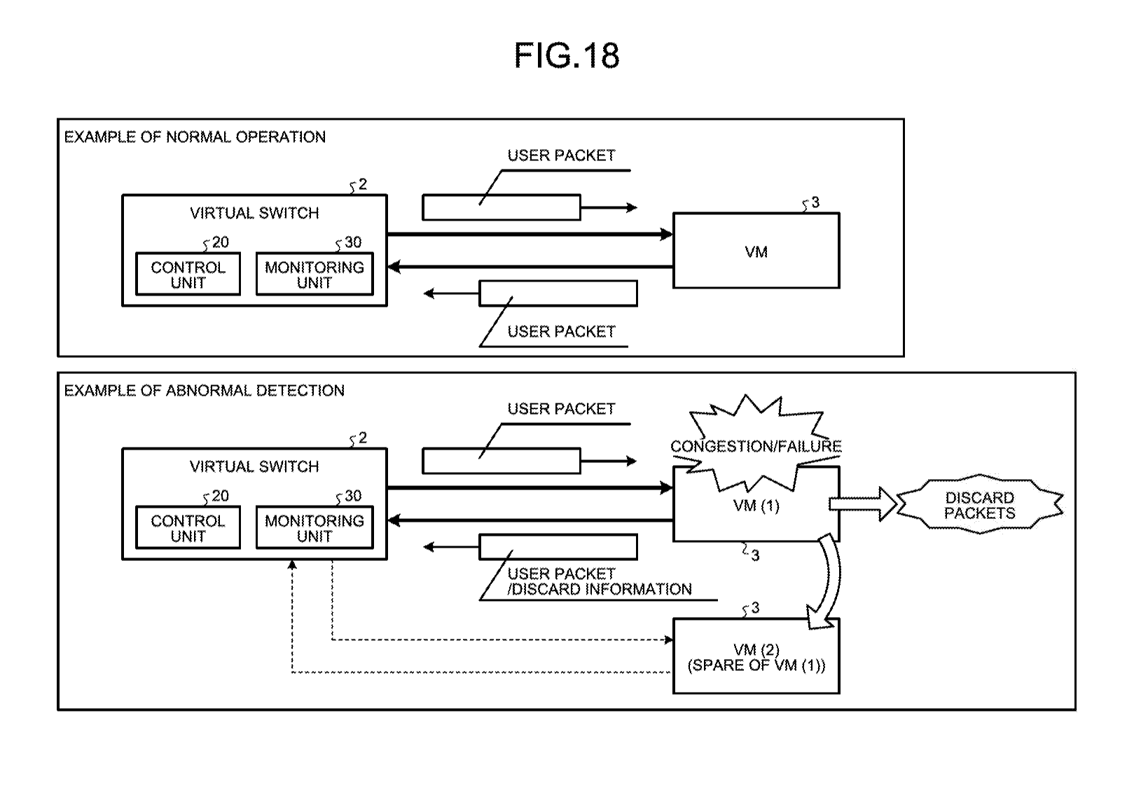

In the following, the flowchart of the abnormality detecting process according to the fourth embodiment will be described with reference to FIG. 19. FIG. 19 is a flowchart illustrating an example of the flow of an abnormality detecting process according to the fourth embodiment. Furthermore, the third abnormality detecting unit 31C regularly or irregularly transmits the monitoring packet to the VM 3 and receives a response monitoring packet from the VM 3.

As illustrated in FIG. 19, the third abnormality detecting unit 31C acquires the number of discards from the response monitoring packet (Step S81). The third abnormality detecting unit 31C determines whether the number of discards is equal to or greater than the second threshold (Step S82).

If it is determined that the number of discards is less than the second threshold (No at Step S82), the third abnormality detecting unit 31C transmits the packets to the VM 3 (Step S83). Then, the third abnormality detecting unit 31C ends the abnormality detecting process.

In contrast, if it is determined that the number of discards is equal to or greater than the second threshold (Yes at Step S82), the third abnormality detecting unit 31C allows the VM switching unit 21 to perform the switching process on the VM 3 (Step S84). Then, the third abnormality detecting unit 31C ends the abnormality detecting process.

Flowchart on the VM Side

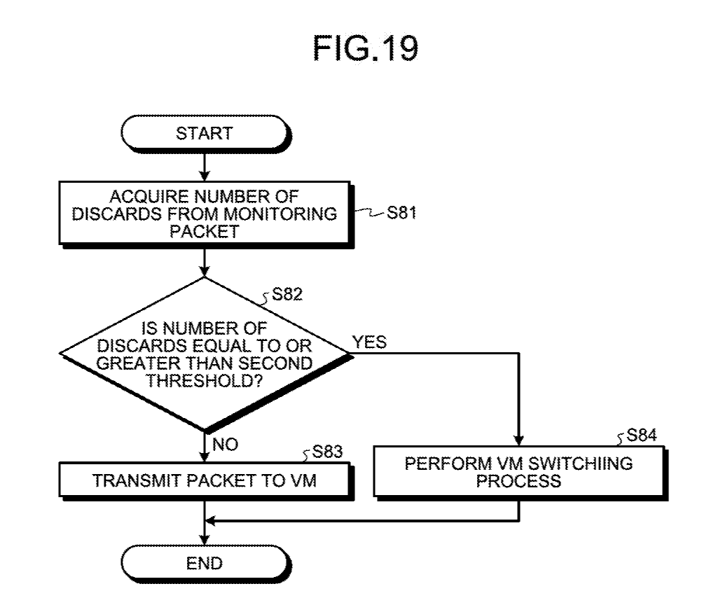

In the following, an example of the flowchart of a process performed on the VM 3 side according to the fourth embodiment will be described with reference to FIG. 20. FIG. 20 is a flowchart illustrating an example of the flow of the process performed on the VM side according to the fourth embodiment.

As illustrated in FIG. 20, the VM 3 determines whether the received packet is a monitoring packet (Step S91). If it is determined that the received packet is not a monitoring packet (No at Step S91), the VM 3 transmits the received packet to the VNF 4 (Step S92).

In contrast, if it is determined that the received packet is a monitoring packet (Yes at Step S91), the VM 3 acquires the number of discards from, for example, the statistical information (Step S93) and then sets the number of discards in the response monitoring packet (Step S94). Then, the VM 3 transmits the response monitoring packet to the virtual switch 2 (Step S95).

### Effect of the Fourth Embodiment

According to the fourth embodiment described above, the virtual switch 2 detects an abnormality of the VM 3 based on the number of packets discarded by the VM 3. Then, the virtual switch 2 switches the VM 3 in which an abnormality has been detected to the new VM 3. With this configuration, the virtual switch 2 detects an abnormality of the VM 3 by using the number of packets discarded by the VM 3 and then switches the VM 3 in which the abnormality has been detected to the new VM 3, whereby the virtual switch 2 can improve the quality of communication.

### [e] Fifth Embodiment

Incidentally, in the server 1 according to the first embodiment, the virtual switch 2 detects an abnormality of the VM 3 that is the transfer destination of the packet and switches the VM 3 in which the abnormality has been detected to the new VM 3. In the server 1 according to the second embodiment, the virtual switch 2 detects an abnormality of the VM 3 that is the transfer destination of the packet by checking the sequence of the plurality of packets to be transferred to the VM 3. In the server 1 according to the third embodiment, the virtual switch 2 inserts the input packets to a queue and detects an abnormality of the VM 3 based on the number of packets that are not extracted from the queue. In the server 1 according to the fourth embodiment, the virtual switch 2 detects an abnormality of the VM 3 based on the number of packets discarded by the VM 3. However, in the server 1, the embodiments are not limited to these and the virtual switch 2 may also detect an abnormality of the VM 3 based on the number of packets transferred to the VM 3, the number of packets sent back from the VM 3, and the number of packets intentionally discarded by the VM 3.

Thus, in a fifth embodiment, a description will be given of a case in which the virtual switch 2 detects an abnormality of the VM 3 based on the number of packets transferred to the VM 3, the number of packets sent back from the VM 3, and the number of packets intentionally discarded by the VM 3.

Configuration of the Server according to the Fifth Embodiment

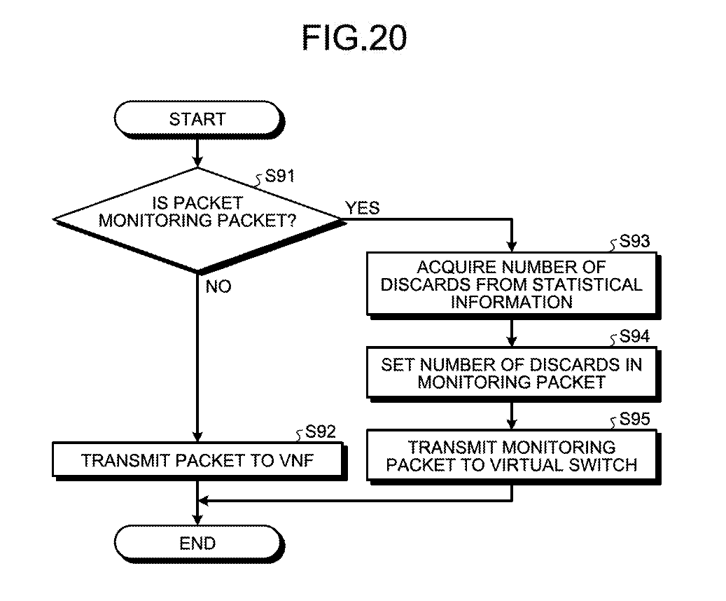

FIG. 21 is a block diagram illustrating the functional configuration of the server according to the fifth embodiment. Furthermore, by assigning the same reference numerals to components having the same configuration as those in the server 1 according to the fourth embodiment illustrated in FIG. 17, overlapped configurations and operations thereof will be omitted. The fifth embodiment differs from the fourth embodiment in that a fourth abnormality detecting unit 31D is added.

The fourth abnormality detecting unit 31D detects an abnormality of the VM 3 based on the number of packets transferred to the VM 3, the number of packets sent back from the VM 3, and the number of packets intentionally discarded by the VM 3. For example, the fourth abnormality detecting unit 31D acquires the number of packets transferred to the VM 3 from the switch counter. The fourth abnormality detecting unit 31D acquires the number of response packets obtained by adding the number of packets sent back from the VM 3 to the number of discards of the packets intentionally discarded by the VM 3. Then, if the value obtained by subtracting the number of response packets from the number of transfer packets is greater than a third threshold, the fourth abnormality detecting unit 31D determines that an abnormality has occurred in the VM 3. Namely, the fourth abnormality detecting unit 31D determines that congestion or a failure has occurred in the VM 3 as the number of response packets is smaller than the number of transfer packets. Furthermore, the number of discards of the packets intentionally discarded is set in a response monitoring packet that is a response to the monitoring packet transferred from, for example, the fourth abnormality detecting unit 31D. Furthermore, the third threshold is previously examined in an experiment and the obtained information is stored in the storage unit 40.

### Example of the Abnormality Detecting Process

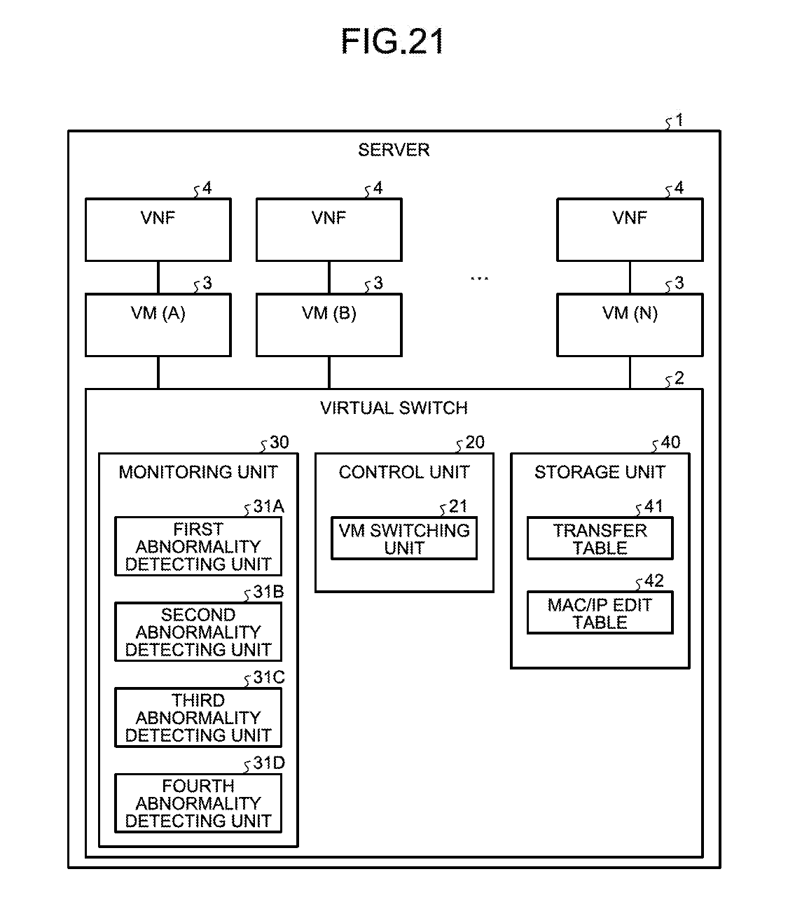

In the following, an example of the abnormality detecting process according to the fifth embodiment will be described with reference to FIG. 22. In the upper portion of FIG. 22, the normal operation of the abnormality detecting process will be described. In the lower portion of FIG. 22, abnormality detection of the abnormality detecting process will be described.

As illustrated in the upper portion of FIG. 22, if the value obtained by subtracting the number of response packets (B+C) from the number of packets (A) transferred to the VM 3 is equal to or less than the third threshold, the fourth abnormality detecting unit 31D determines that no abnormality occurs in the VM 3. The number of response packets is the value obtained by adding the number of packets (B) sent back from the VM 3 to the number of discards (C) of the packets that are intentionally discarded by the VM 3. Here, it is assumed that the third threshold is a predetermined value that is greater than zero. It is assumed that the number of packets (A) transferred to the VM 3 matches the number of response packets (B+C). Then, because the value obtained by subtracting the number of response packets (B+C) from the number of packets (A) transferred to the VM 3 is zero and the obtained value is equal to or less than the third threshold, the fourth abnormality detecting unit 31D determines that no abnormality occurs in the VM 3.

As illustrated in the lower portion of FIG. 22, if the value obtained by subtracting the number of response packets (B+C) from the number of packets (A) transferred to the VM 3 is greater than the third threshold, the fourth abnormality detecting unit 31D determines that an abnormality has occurred in the VM 3. Here, it is assumed that the number of packets (A) transferred to the VM 3 does not match the number of response packets (B+C). Then, if the value obtained by subtracting the number of response packets (B+C) from the number of packets (A) transferred to the VM 3 is greater than the third threshold, the fourth abnormality detecting unit 31D determines that an abnormality has occurred in the VM 3.

Thus, the VM switching unit 21 in the control unit 20 switches the VM 3 in which it is determined that an abnormality has occurred to the spare VM 3.

Flowchart of the Abnormality Detecting Process

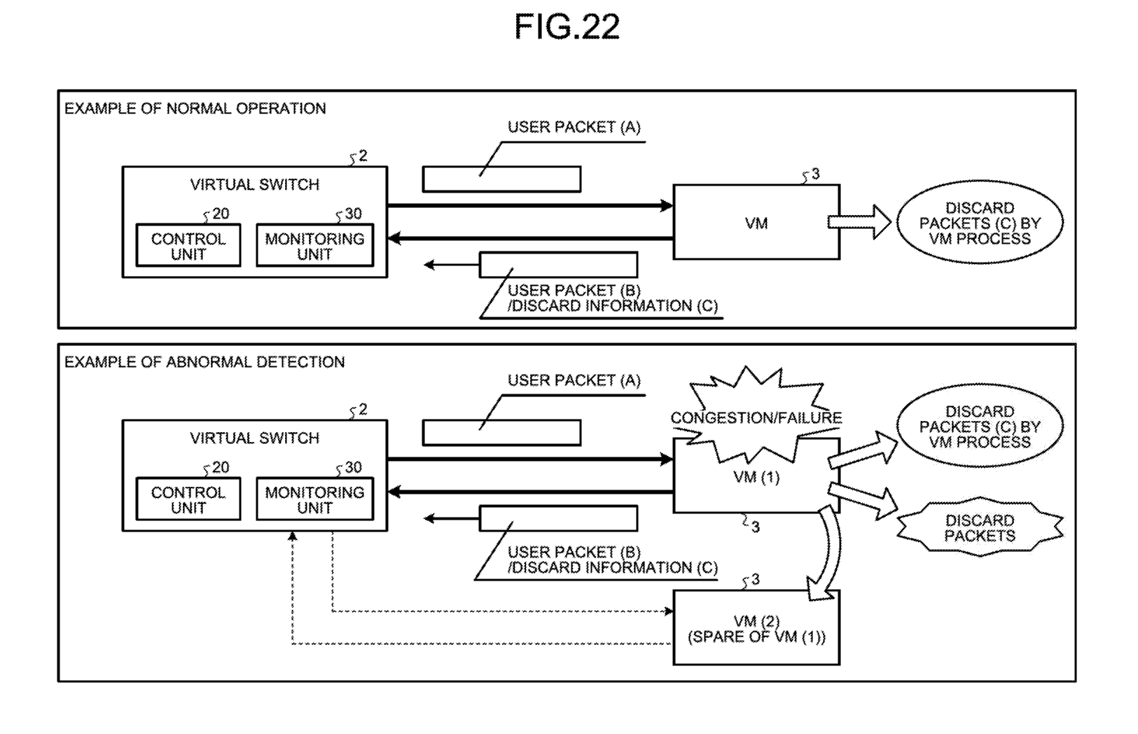

In the following, the flowchart of the abnormality detecting process according to the fifth embodiment will be described with reference to FIG. 23. FIG. 23 is a flowchart illustrating an example of the flow of the abnormality detecting process according to the fifth embodiment. Furthermore, the fourth abnormality detecting unit 31D regularly or irregularly transmits the monitoring packet to the VM 3 and receives the response monitoring packet from the VM 3.

As illustrated in FIG. 23, the fourth abnormality detecting unit 31D acquires, from the switch counter, the number of transmissions (A) that indicates the number of packets transferred to the VM 3 (Step S101). The fourth abnormality detecting unit 31D acquires, from the switch counter, the number of receptions (B) that indicates the number of packets sent back from the VM 3 (Step S102).

The fourth abnormality detecting unit 31D acquires, from the response monitoring packet, the number of discards (C) of the packets that have been intentionally discarded (Step S103).

Then, the fourth abnormality detecting unit 31D determines whether A-(B+C) is equal to or greater than the third threshold (Step S104). Namely, the fourth abnormality detecting unit 31D determines whether the value obtained by subtracting the number of response packets (B+C) from the number of transmissions (A) is greater than the third threshold. If it is determined that A−(B+C) is equal to or less than the third threshold (No at Step S104), the fourth abnormality detecting unit 31D ends the abnormality detecting process.

In contrast, A−(B+C) is equal to or greater than the third threshold (Yes at Step S104), the fourth abnormality detecting unit 31D allows the VM switching unit 21 to perform the switching process on the VM 3 (Step S105). Then, the fourth abnormality detecting unit 31D ends the abnormality detecting process.

Flowchart on the VM Side

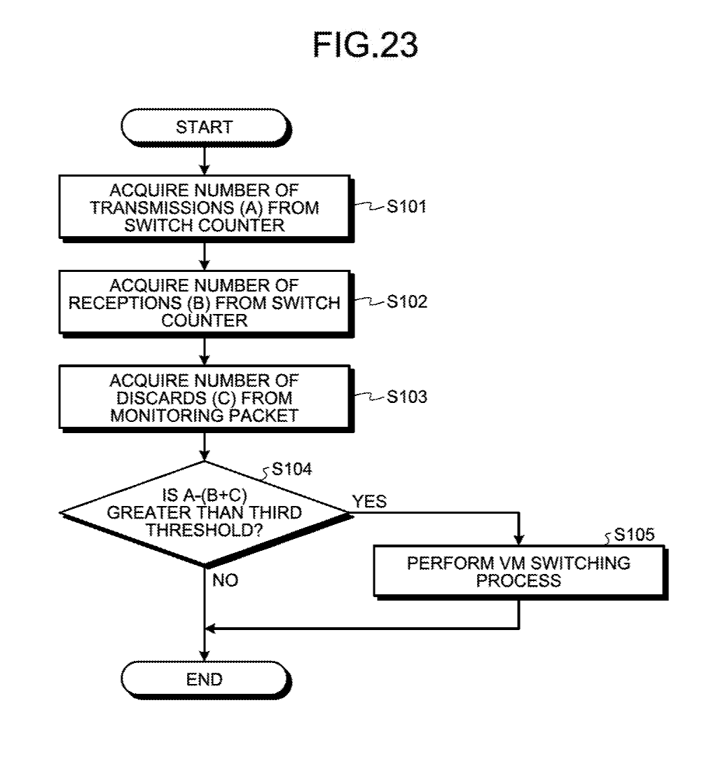

In the following, an example of the flowchart of a process performed on the VM 3 side according to the fifth embodiment will be described with reference to FIG. 24. FIG. 24 is a flowchart illustrating an example of the flow of a process performed on the VM side according to the fifth embodiment.

As illustrated in FIG. 24, the VM 3 determines whether the received packet is the monitoring packet (Step S111). If it is determined that the received packet is not the monitoring packet (No at Step S111), the VM 3 transmits the received packet to the VNF 4 (Step S112).

In contrast, if it is determined that the received packet is the monitoring packet (Yes at Step S111), the VM 3 acquires the number of discards pf the packets that have been intentionally discarded from, for example, the statistical information (Step S113). Then, the VM 3 sets the number of discards in the response monitoring packet (Step S114). Then, the VM 3 transmits the response monitoring packet to the virtual switch 2 (Step S115).

### Effect of the Fifth Embodiment

According to the fifth embodiment described above, the virtual switch 2 detects an abnormality of the VM 3 based on the number of packets transferred to the VM 3, the number of packets sent back from the VM 3, and the number of packets discarded by the VM 3. Then, the virtual switch 2 switches the VM 3 in which the abnormality has been detected to the new VM 3. With this configuration, the virtual switch 2 detects the abnormality of the VM 3 by using the number of packets transferred to the VM 3, the number of packets sent back from the VM 3, and the number of packets discarded by the VM 3 and switches the VM 3 in which the abnormality has been detected to the new VM 3, whereby the virtual switch 2 can improve the quality of communication.

### [f] Sixth Embodiment

Incidentally, in the server 1 according to the first embodiment, the virtual switch 2 detects an abnormality of the VM 3 that is the transfer destination of the packet and switches the VM 3 in which the abnormality has been detected to the new VM 3. In the server 1 according to the second embodiment, the virtual switch 2 detects an abnormality of the VM 3 that is the transfer destination of the packet by checking the sequence of the plurality of packets transferred to the VM 3. In the server 1 according to the third embodiment, the virtual switch 2 inserts the input packets into a queue and then detects an abnormality of the VM 3 based on the number of packets that are not extracted from the queue. In the server 1 according to the fourth embodiment, the virtual switch 2 detects an abnormality of the VM 3 based on the number of packets discarded by the VM 3. In the server 1 according to the fifth embodiment, the virtual switch 2 detects an abnormality of the VM 3 based on the number of packets transferred to the VM 3, the number of packets sent back from the VM 3, and the number of packets that have been intentionally discarded by the VM 3. However, in the server 1, the embodiments are not limited to these and the virtual switch 2 may also detect an abnormality of the VM 3 based on the VM statistical information that indicates the state of the VM 3. An example of the VM statistical information mentioned here includes a CPU usage rate or a temperature; however, the VM statistical information is not limited to this.

Thus, in a sixth embodiment, a description will be given of a case in which the virtual switch 2 detects an abnormality of the VM 3 based on the VM statistical information that indicates the state of the VM 3.

### Configuration of the Server according to the Sixth Embodiment

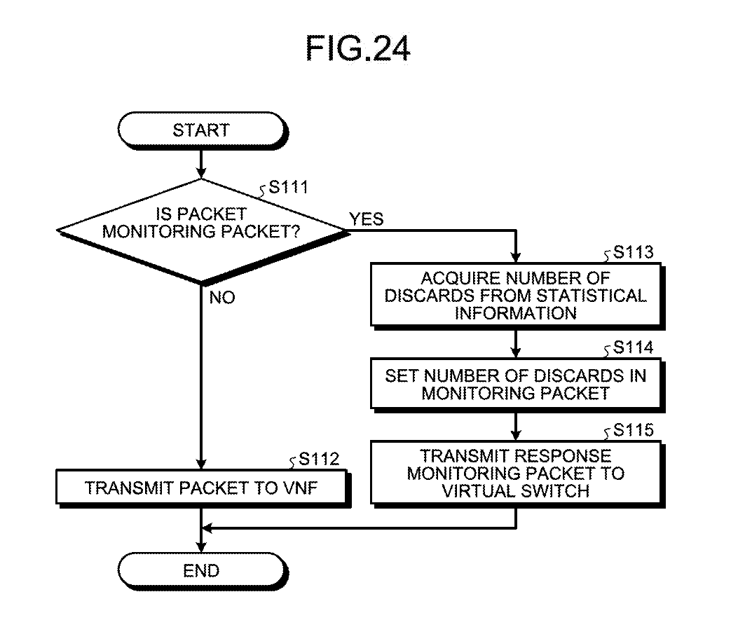

FIG. 25 is a block diagram illustrating the functional configuration of the server according to the sixth embodiment. Furthermore, by assigning the same reference numerals to components having the same configuration as those in the server 1 according to the fifth embodiment illustrated in FIG. 21, overlapped configurations and operations thereof will be omitted. The sixth embodiment differs from the fifth embodiment in that a fifth abnormality detecting unit 31E is added.

The fifth abnormality detecting unit 31E detects an abnormality of the VM 3 based on the VM statistical information that indicates the state of the VM 3. For example, if the VM statistical information is greater than a fourth threshold, the fifth abnormality detecting unit 31E determines that an abnormality has occurred in the VM 3. Furthermore, the fourth threshold varies in accordance with the content of the VM statistical information and is previously examined in an experiment and the obtained information is stored in the storage unit 40.

### Example of the Abnormality Detecting Process

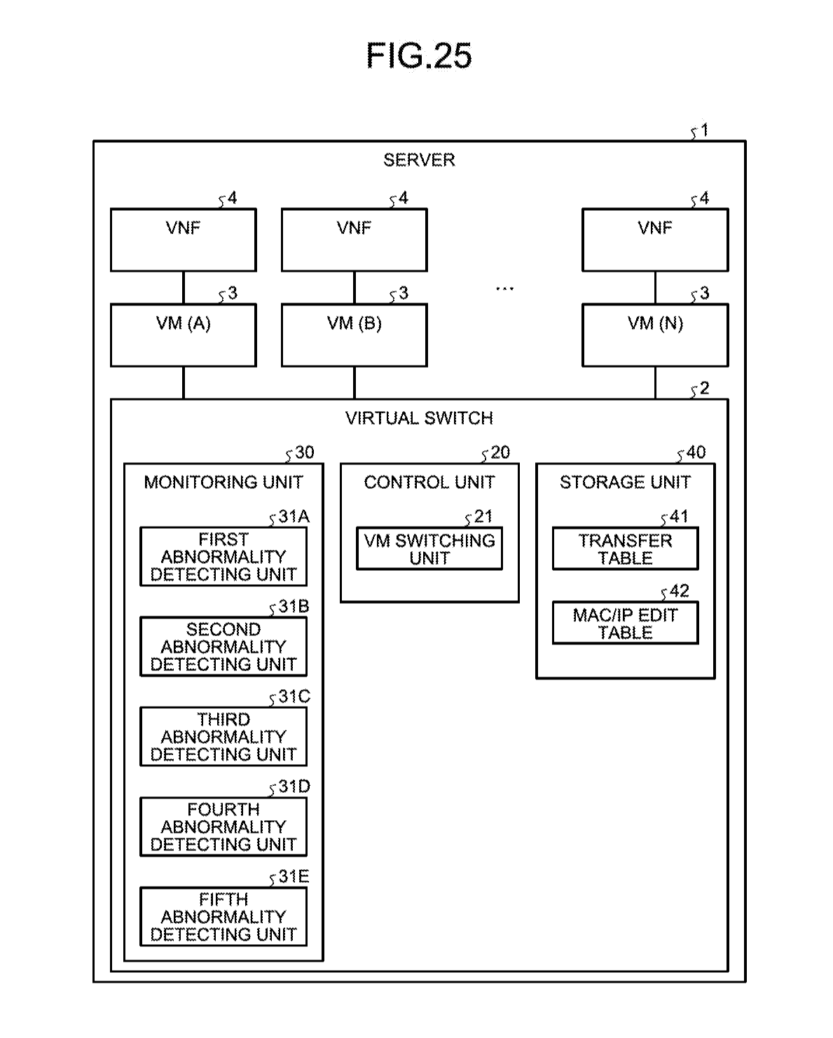

In the following, an example of the abnormality detecting process according to the sixth embodiment will be described with reference with FIG. 26. In the upper portion of FIG. 26, the normal operation of the abnormality detecting process will be described. In the lower portion of FIG. 26, abnormality detection performed in the abnormality detecting process will be described. Furthermore, it is assumed that the VM statistical information is, for example, the CPU usage rate and it is assumed that the fourth threshold is, for example, 90%.

As illustrated in the upper portion of FIG. 26, if the VM statistical information transmitted from the VM 3 is equal to or less than the fourth threshold, the fifth abnormality detecting unit 31E determines that no abnormality occurs in the VM 3. Here, it is assumed that the VM statistical information transmitted from the VM 3 is 50%. Then, because the VM statistical information transmitted from the VM 3 is equal to or less than the fourth threshold (90%), the fifth abnormality detecting unit 31E determines that no abnormality occurs in the VM 3.

As illustrated in the lower portion of FIG. 26, if the VM statistical information transmitted from the VM 3 is greater than the fourth threshold, the fifth abnormality detecting unit 31E determines that an abnormality has occurred in the VM 3. Here, it is assumed that the VM statistical information transmitted from the VM 3 is 95%. Then, because the VM statistical information transmitted from the VM 3 is greater than the fourth threshold (90%), the fifth abnormality detecting unit 31E determines that an abnormality has been occurred in the VM 3.

Thus, the VM switching unit 21 in the control unit 20 switches the VM 3 in which it is determined that an abnormality has occurred to the spare VM 3.

Flowchart of the Abnormality Detecting Process

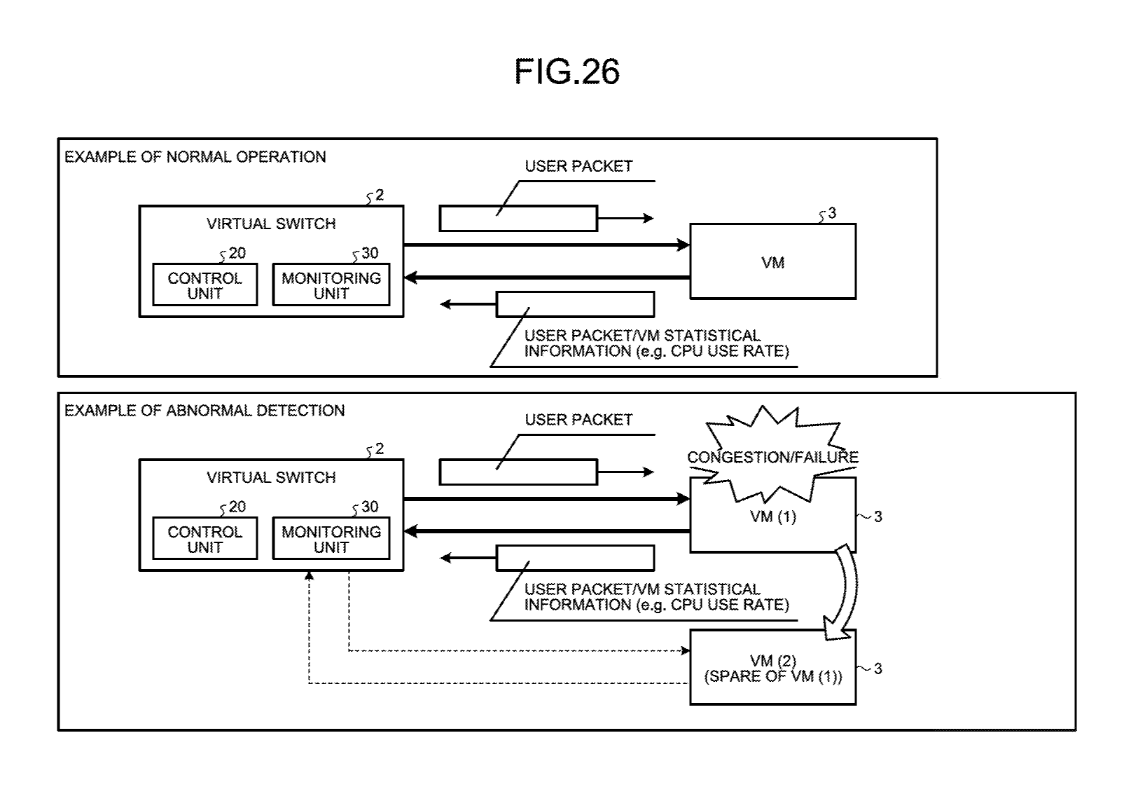

In the following, the flowchart of the abnormality detecting process according to the sixth embodiment will be described with reference to FIG. 27. FIG. 27 is a schematic diagram illustrating the flowchart of the abnormality detecting process according to the sixth embodiment. Furthermore, the fifth abnormality detecting unit 31E regularly or irregularly transmits the monitoring packet to the VM 3 and receives the response monitoring packet from the VM 3.

As illustrated in FIG. 27, the fifth abnormality detecting unit 31E acquires the parameter (VM statistical information) from the response monitoring packet (Step S121).

Then, the fifth abnormality detecting unit 31E determines whether the parameter is greater than the fourth threshold (Step S122). If it is determined that the parameter is equal to or less than the fourth threshold (No at Step S122), the fifth abnormality detecting unit 31E ends the abnormality detecting process.

In contrast, if it is determined that the parameter is greater than the fourth threshold (Yes at Step S122), the fifth abnormality detecting unit 31E allows the VM switching unit 21 to perform the switching process on the VM 3 (Step S123). Then, the fifth abnormality detecting unit 31E ends the abnormality detecting process.

Flowchart on the VM Side

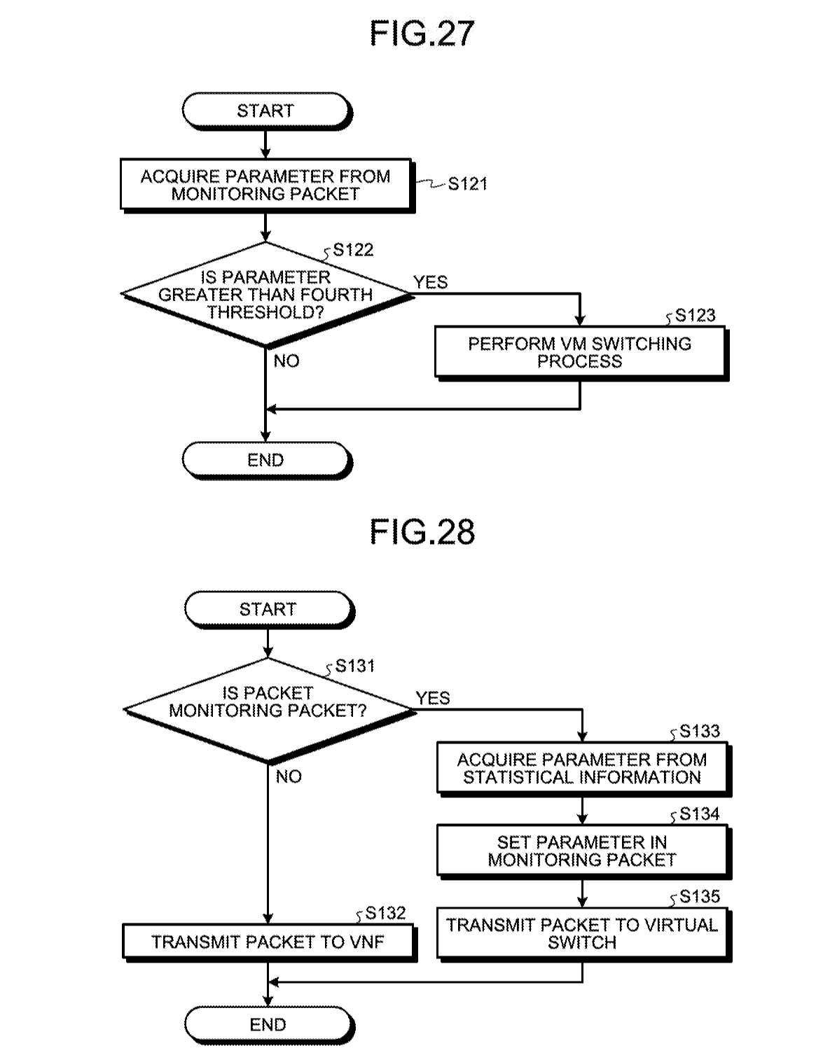

In the following, an example of the flowchart of a process performed on the VM 3 side according to the sixth embodiment will be described with reference to FIG. 28. FIG. 28 is a flowchart illustrating an example of the process performed on the VM side according to the sixth embodiment.

As illustrated in FIG. 28, the VM 3 determines whether the received packet is the monitoring packet (Step S131). If it is determined that the received packet is not the monitoring packet (No at Step S131), the VM 3 transmits the received packet to the VNF 4 (Step S132).

In contrast, if it is determined that the received packet is the monitoring packet (Yes at Step S131), the VM 3 acquires the parameter (VM statistical information) from, for example, the statistical information (Step S133). Then, the VM 3 sets the parameter in the response monitoring packet (Step S134). Then, the VM 3 transmits the response monitoring packet to the virtual switch 2 (Step S135).

### Effect of the Sixth Embodiment

According to the sixth embodiment described above, the virtual switch 2 detects an abnormality of the VM 3 based on the VM statistical information that indicates the state of the VM 3. Then, the virtual switch 2 switches the VM 3 in which the abnormality has been detected to the new VM 3. With this configuration, the virtual switch 2 detects an abnormality of the VM 3 by using the VM statistical information that indicates the state of the VM 3 and switches the VM 3 in which the abnormality has been detected to the new VM 3, whereby the virtual switch 2 can improve the quality of communication.

### [g] Seventh Embodiment

Incidentally, in the server 1 according to the first embodiment, the virtual switch 2 detects an abnormality of the VM 3 that is the transfer destination of a packet and switches the VM 3 in which the abnormality has been detected to the new VM 3. In the server 1 according to the second embodiment, the virtual switch 2 detects an abnormality of the VM 3 that is the transfer destination of a packet by checking the sequence of a plurality of packets to be transferred to the VM 3. In the server 1 according to the third embodiment, the virtual switch 2 inserts the input packets to a queue and detects an abnormality of the VM 3 based on the number of packets that are not extracted from the queue. In the server 1 according to the fourth embodiment, the virtual switch 2 detects an abnormality of the VM 3 based on the number of packets that have been discarded by the VM 3. In the server 1 according to the fifth embodiment, the virtual switch 2 detects an abnormality of the VM 3 based on the number of packets transferred to the VM 3, the number of packets sent back from the VM 3, and the number of packets that have been intentionally discarded by the VM 3. In the server 1 according to the sixth embodiment, the virtual switch 2 detects an abnormality of the VM 3 based on the VM statistical information that indicates the state of the VM 3. However, in the server 1, the embodiments are not limited to these and the virtual switch 2 may also detect an abnormality of the VM 3 based on a time difference between the time when a packet is transferred to the VM 3 and the time when a response to the packet arrives.

Thus, in a seventh embodiment, a description will be given of a case in which the virtual switch 2 detects an abnormality of the VM 3 based on a time difference between the time when a packet is transferred to the VM 3 and the time when a response to the packet arrives.

### Configuration of the Server according to the Seventh Embodiment

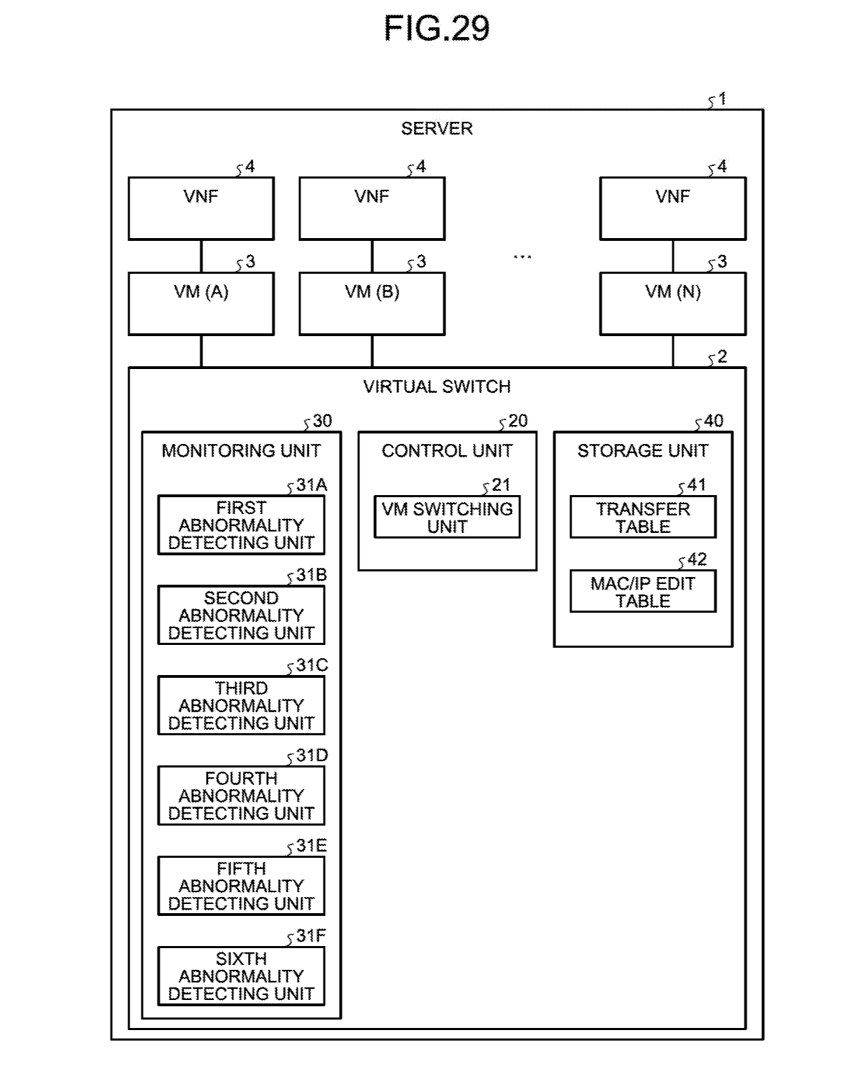

FIG. 29 is a block diagram illustrating the functional configuration of the server according to the seventh embodiment. Furthermore, by assigning the same reference numerals to components having the same configuration as those in the server 1 according to the sixth embodiment illustrated in FIG. 25, overlapped configurations and operations thereof will be omitted. The seventh embodiment differs from the sixth embodiment in that a sixth abnormality detecting unit 31F is added.

The sixth abnormality detecting unit 31F detects an abnormality of the VM 3 based on a time difference between the time when the packet is transferred to the VM 3 and the time when a response to the packet arrives. For example, the sixth abnormality detecting unit 31F transfers a packet to the VM 3 and holds the time when transferring the packet. The sixth abnormality detecting unit 31F holds the time when a response packet that is a respect to the packet transferred to the VM 3 arrives. If a time difference between the time when the packet is transferred to the VM 3 and the time when a response arrives from the VM 3 is greater than a fifth threshold, the sixth abnormality detecting unit 31F determines that an abnormality has occurred in the VM 3. Furthermore, the fifth threshold is previously examined in an experiment and the obtained information is stored in the storage unit 40.

### Example of the Abnormality Detecting Process

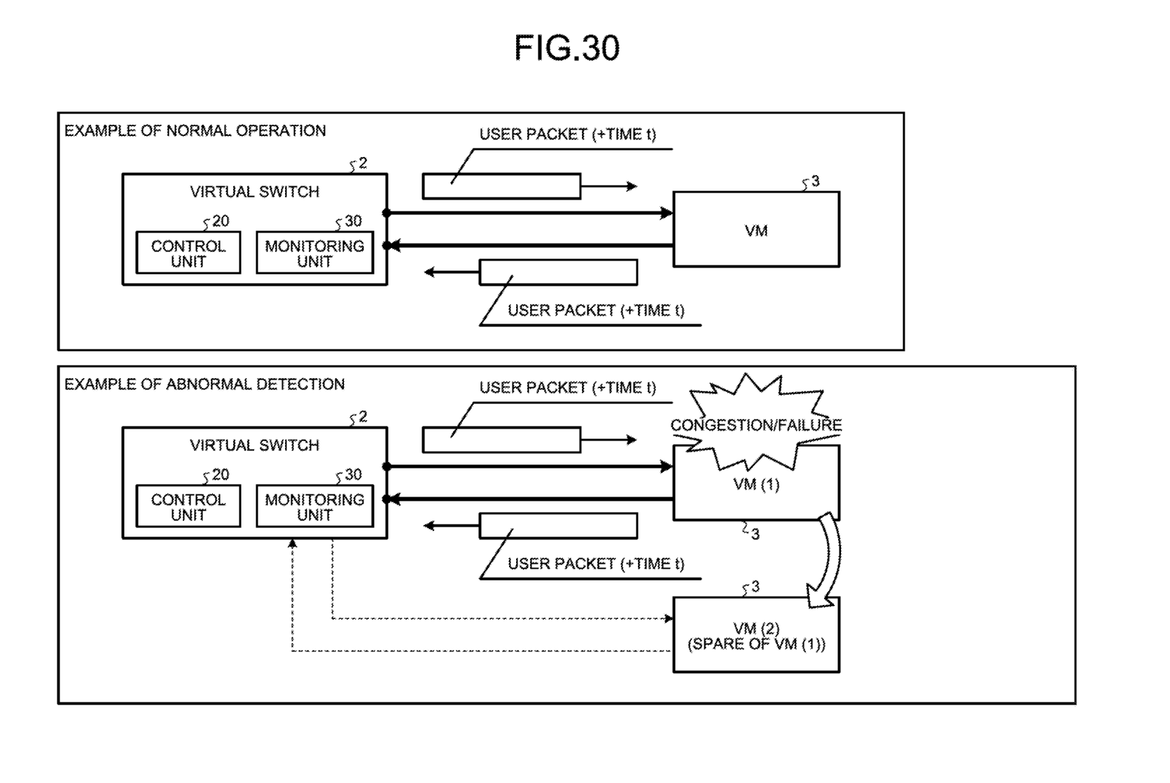

In the following, an example of the abnormality detecting process according to the seventh embodiment will be described with reference to FIG. 30. In the upper portion of FIG. 30, the normal operation of the abnormality detecting process will be described. In the lower portion of FIG. 30, abnormality detection of the abnormality detecting process will be described.

As illustrated in the upper portion of FIG. 30, if a time difference between the time when a packet transferred to the VM 3 and the time when a response arrives from the VM 3 is equal to or less than the fifth threshold, the sixth abnormality detecting unit 31F determines that no abnormality occurs in the VM 3. Here, it is assumed that the time when the packet is transferred to the VM 3 is time t and it is assumed that the time when the packet arrives from the VM 3 is t+Δt. Then, if a time difference Δt is equal to or less than the fifth threshold, the sixth abnormality detecting unit 31F determines that no abnormality occurs in the VM 3.

As illustrated in the lower portion of FIG. 30, if a time difference between the time when a packet is transferred to the VM 3 and the time when a response arrives from the VM 3 is greater than the fifth threshold, the sixth abnormality detecting unit 31F determines that an abnormality has occurred in the VM 3. Here, it is assumed that the time when the packet is transferred to the VM 3 is time t and it is assumed that the time when the response arrives from the VM 3 is t+Δt. Then, if a time difference Δt is greater than the fifth threshold, the sixth abnormality detecting unit 31F determines that an abnormality has occurred in the VM 3.

Thus, the VM switching unit 21 in the control unit 20 switches the VM 3 in which it is determined that an abnormality has occurred to the spare VM 3.

Flowchart of the Abnormality Detecting Process

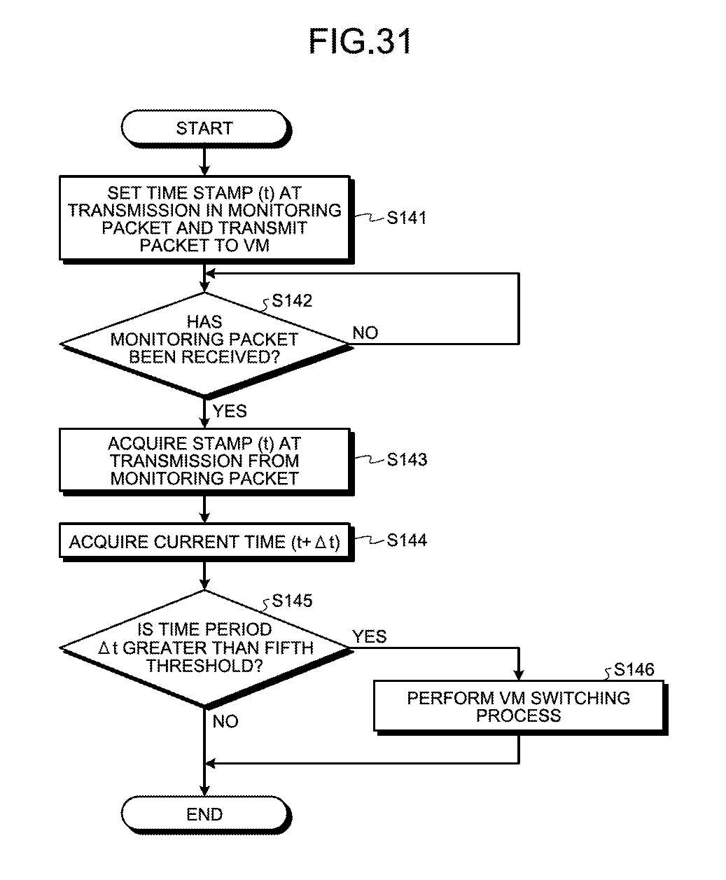

In the following, the flowchart of the abnormality detecting process according to the seventh embodiment will be described with reference to FIG. 31. FIG. 31 is a flowchart illustrating an example of the abnormality detecting process according to the seventh embodiment.

As illustrated in FIG. 31, the sixth abnormality detecting unit 31F sets a time stamp (t) at the time of transmission in the monitoring packet and transmits the packet to the VM 3 (Step S141).

The sixth abnormality detecting unit 31F determines whether a response monitoring packet that is a response to the monitoring packet transmitted to the VM 3 has been received (Step S142). If it is determined that the monitoring packet has not been received (No at Step S142), the sixth abnormality detecting unit 31F repeats the determination process until the sixth abnormality detecting unit 31F receives the monitoring packet.

In contrast, if it is determined that the monitoring packet has been received (Yes at Step S142), the sixth abnormality detecting unit 31F acquires the time stamp (t) of the transmission from the received monitoring packet (Step S143). The sixth abnormality detecting unit 31F acquires the current time (t+Δt) when the monitoring packet has been received (Step S144).

The sixth abnormality detecting unit 31F determines whether the time period Δt is greater than the fifth threshold (Step S145). If it is determined that the time period Δt is equal to or less than the fifth threshold (No at Step S145), the sixth abnormality detecting unit 31F ends the abnormality detecting process.

In contrast, if it is determined that the time period Δt is greater than the fifth threshold (Yes at Step S145), the sixth abnormality detecting unit 31F allows the VM switching unit 21 to perform the switching process on the VM 3 (Step S146). Then, the sixth abnormality detecting unit 31F ends the abnormality detecting process.

Flowchart on the VM Side

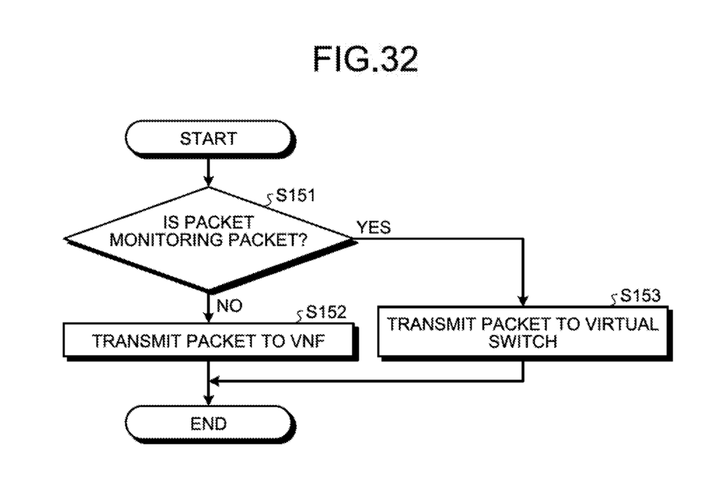

In the following, an example of the flowchart of a process performed on the VM 3 side according to the seventh embodiment will be described with reference to FIG. 32. FIG. 32 is a flowchart illustrating the flow of a process performed on the VM side according to the seventh embodiment.

As illustrated in FIG. 32, the VM 3 determines whether the received packet is the monitoring packet (Step S151). If it is determined that the received packet is not the monitoring packet (No at Step S151), the VM 3 transmits the received packet to the VNF 4 (Step S152).

In contrast, if the received packet is the monitoring packet (Yes at Step S151), the VM 3 transmits the response monitoring packet to the virtual switch 2 (Step S153).

### Effect of the Seventh Embodiment

According to the seventh embodiment described above, the virtual switch 2 detects an abnormality of the VM 3 based on a time difference between the time when a packet is transferred to the VM 3 and the time when a response to the packet arrives. Then, the virtual switch 2 switches the VM 3 in which the abnormality has been detected to the new VM 3. With this configuration, the virtual switch 2 detects an abnormality of the VM 3 by using a time difference between the time when the packet is transferred to the VM 3 and the time when a response to the packet arrives and then switches the VM 3 in which the abnormality has been detected to the new VM 3, whereby the virtual switch 2 can improve the quality of communication.

Others

Furthermore, in the second to the seventh embodiments, an example has been described in which the monitoring unit 30 performs the abnormality detecting process of detecting an abnormality of the VM 3 by using individual methods. Namely, in the second embodiment, the monitoring unit 30 detects an abnormality of the VM 3 by checking the sequence of the packets (a first abnormality detection method). In the third embodiment, the monitoring unit 30 detects an abnormality of the VM 3 by checking the queue length of the packets (a second abnormality detection method). In the fourth embodiment, the monitoring unit 30 detects an abnormality of the VM 3 by checking the packet discard information stored in the VM 3 (a third abnormality detection method). In the fifth embodiment, the monitoring unit 30 detects an abnormality of the VM 3 based on a difference between the number of transmission and reception packets to and from the VM 3 (a fourth abnormality detection method). In the sixth embodiment, the monitoring unit 30 detects an abnormality of the VM 3 by checking the VM statistical information (a fifth abnormality detection method). In the seventh embodiment, the monitoring unit 30 detects an abnormality pf the VM 3 by using a time stamp of transmission/reception of the packet to and from the VM 3 (a sixth abnormality detection method). However, the monitoring unit 30 is not limited to these and may also detect an abnormality of the VM 3 by combining each of the methods. For example, the monitoring unit 30 may also detect an abnormality of the VM 3 by combining the first abnormality detection method and the sixth abnormality detection method. Consequently, the monitoring unit 30 can improve the accuracy of abnormality detection of the VM 3.

Furthermore, each of the components of the devices illustrated in the drawings is not always physically configured as illustrated in the drawings. Namely, the specific shape of a separate or integrated device is not limited to the drawings. Specifically, all or part of the device can be configured by functionally or physically separating or integrating any of the units depending on various loads or use conditions. For example, the VM switching unit 21 may also be separated into a first VM switching unit in a case where a packet is transferred from the WAN to the VM 3 and a second VM switching unit in a case where a packet is transferred from the VM 3 to the WAN. Furthermore, the storage unit 40 may also be connected as an external device of the server 1 via a network.

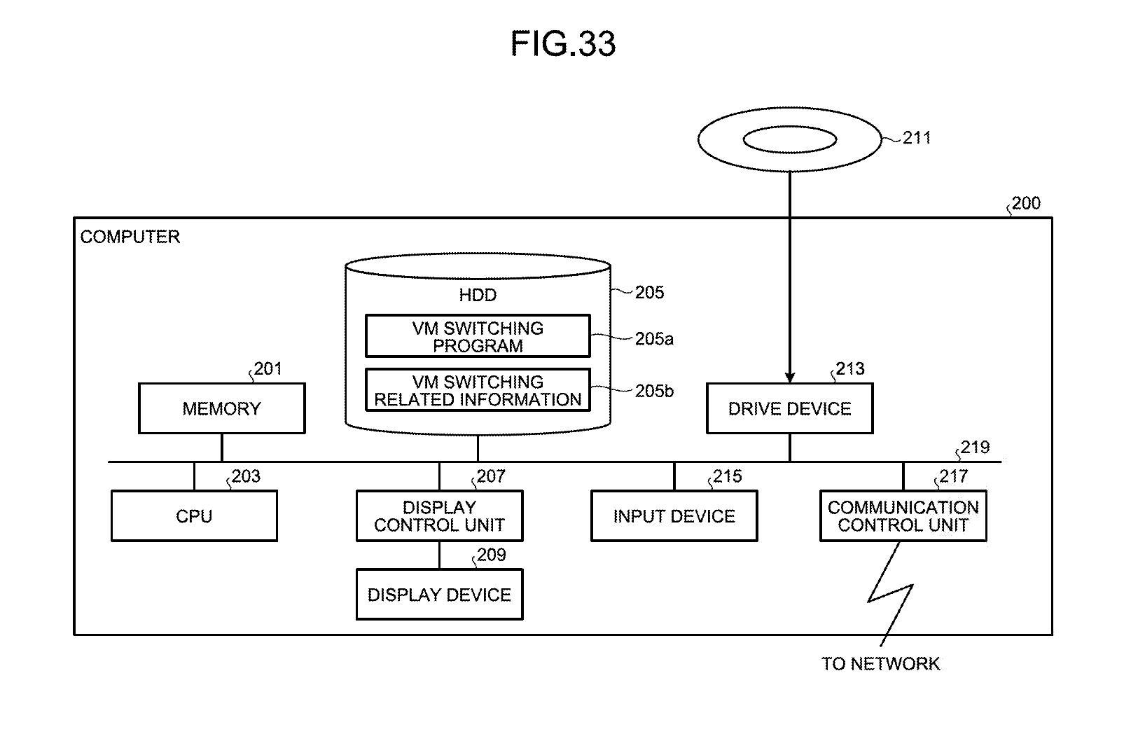

Furthermore, the various processes described in the embodiments can be implemented by a program prepared in advance and executed by a computer such as a personal computer or a workstation. Accordingly, in the following, an example of a computer that executes a VM switching program that implements the same function as that performed by the server 1 illustrated in FIG. 1 will be described. FIG. 33 is a block diagram illustrating an example of a computer that executes a VM switching program.

As illustrated in FIG. 33, a computer 200 includes a CPU 203 that executes various kinds of arithmetic processing, an input device 215 that receives an input of data from a user, and a display control unit 207 that controls a display device 209. Furthermore, the computer 200 includes a drive device 213 that reads programs or the like from a storage medium and a communication control unit 217 that sends and receives data to and from another computer via the network. Furthermore, the computer 200 includes a memory 201 that temporarily stores therein various kinds of information and an HDD 205. Then, the memory 201, the CPU 203, the HDD 205, the display control unit 207, the drive device 213, the input device 215, and the communication control unit 217 are connected by a bus 219.

The drive device 213 is a device used for, for example, a removable disk 211. The HDD 205 stores therein a VM switching program 205a and VM switching related information 205b.

The CPU 203 reads the VM switching program 205a, loads the read program in the memory 201, and executes the loaded program as a process. The process mentioned here corresponds to each of the functioning units in the server 1. The VM switching related information 205b corresponds to the transfer table 41 and the MAC/IP edit table 42.

Then, for example, the removable disk 211 stores therein each of the pieces of information, such as the VM switching program 205a, or the like.

Furthermore, the VM switching program 205a does not need to be stored in the HDD 205 from the beginning. For example, the VM switching program 205a is stored in a “portable physical medium”, such as a flexible disk (FD), a CD-ROM, a DVD disk, a magneto-optic disk, an IC CARD, or the like, that is to be inserted into the computer 200. Then, the computer 200 may also read and execute the VM switching program 205a from the portable physical medium.

According to an aspect of an embodiment, in the NFV technology, it is possible to speed up the switching of VMs.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a VM switching program that causes a computer to execute a process, the process comprising:
detecting an abnormality of a VM that is a transfer destination of a packet and rewriting, when switching of the VM has been performed, a first association relationship between a transfer destination MAC address and a port number of the VM that is before the switching to a first association relationship between the MAC address and a port number of the switched VM;
deciding, from the port number that is matched based on the rewritten first association relationship and a second association relationship among a port number of the switched VM that is the transfer destination, a transfer destination MAC address, and a transfer destination IP address, the transfer destination MAC address and the transfer destination IP address of the switched VM;
rewriting both the transfer destination MAC address and the transfer destination IP address that are included in the header of the packet received from an external network to both the decided MAC address and the decided IP address; and
transferring the rewritten packet to the switched VM.

2. The non-transitory computer-readable recording medium according to claim 1, the process further including:
rewriting, when the switching of the VM has been performed, a third association relationship among the port number of the switched VM, a transfer source MAC address that is after the switching, and a transfer source IP address that is after the switching to a third association relationship among the port number of the switched VM, a transfer source MAC address that is before the switching, and a transfer source IP address that is before the switching;
rewriting, based on the rewritten third association relationship, both the transfer source MAC address and the transfer source IP address that are included in the header of a packet transferred from the switched VM to both the rewritten MAC address and the rewritten IP address; and
transferring the rewritten packet to the external network.

3. The non-transitory computer-readable recording medium according to claim 1, wherein the detecting the abnormality includes detecting the abnormality of the VM based on the sequence of the packets at the time of transferring the packets to the VM and based on the sequence of the packets sent back from the VM.

4. The non-transitory computer-readable recording medium according to claim 1, wherein the detecting the abnormality includes inserting the input packets into a queue and detecting the abnormality of the VM based on the number of packets that are not extracted from the queue.

5. The non-transitory computer-readable recording medium according to claim 1, wherein the detecting the abnormality includes detecting the abnormality of the VM based on the number of packets discarded by the VM.

6. The non-transitory computer-readable recording medium according to claim 1, wherein the detecting the abnormality includes detecting the abnormality of the VM based on the number of packets transferred to the VM, the number of packets sent back from the VM, and the number of packets discarded by the VM.

7. The non-transitory computer-readable recording medium according to claim 1, wherein the detecting the abnormality includes detecting the abnormality of the VM based on statistical information that indicates the state of the VM.

8. The non-transitory computer-readable recording medium according to claim 1, wherein the detecting the abnormality includes detecting the abnormality of the VM based on a time difference between the time when the packet is transferred to the VM and the time when a response to the packet arrives.

9. An information processing apparatus comprising:
a processor;
a memory, wherein the processor executes a process comprising:
detecting an abnormality of a VM that is a transfer destination of a packet and rewriting, when switching of the VM has been performed, a first association relationship between a transfer destination MAC address and a port number of the VM that is before the switching to a first association relationship between the MAC address and a port number of the switched VM;
deciding, from the port number that is matched based on the rewritten first association relationship and a second association relationship among a port number of the switched VM that is the transfer destination, a transfer destination MAC address, and a transfer destination IP address, the transfer destination MAC address and the transfer destination IP address of the switched VM;
rewriting both the transfer destination MAC address and the transfer destination IP address that are included in the header of the packet received from an external network to both the decided MAC address and the decided IP address; and
transferring the rewritten packet to the switched VM.

10. A VM switching method to be performed by a computer, the VM switching method comprising:
detecting an abnormality of a VM that is a transfer destination of a packet and rewriting, when switching of the VM has been performed, a first association relationship between a transfer destination MAC address and a port number of the VM that is before the switching to a first association relationship between the MAC address and a port number of the switched VM using a processor;
deciding, from the port number that is matched based on the rewritten first association relationship and a second association relationship among a port number of the switched VM that is the transfer destination, a transfer destination MAC address, and a transfer destination IP address, the transfer destination MAC address and the transfer destination IP address of the switched VM using the processor;
rewriting both the transfer destination MAC address and the transfer destination IP address that are included in the header of the packet received from an external network to both the decided MAC address and the decided IP address using the processor; and
transferring the rewritten packet to the switched VM using the processor.
